(19) United States
(12) Patent Application Publication
(10) Pub. No.: US 2026/0004402 A1
(43) Pub. Date: Jan. 1, 2026

(54) METHODS AND APPARATUS FOR FRAME DENOISING

(71) Applicant: GoPro, Inc., San Mateo, CA (US)

(72) Inventor: Robert McIntosh, Marina Del Rey, CA (US)

(73) Assignee: GoPro, Inc., San Mateo, CA (US)

(21) Appl. No.: 18/759,992

(22) Filed: Jun. 30, 2024

(51) Int. Cl. G06T 5/50; G06T 3/18; G06T 5/70; G06T 7/12; G06T 7/13; G06T 7/20; G06T 9/00; G06V 10/60; G06V 10/75

(52) U.S. Cl. CPC G06T 5/50; G06T 3/18; G06T 5/70; G06T 7/12; G06T 7/13; G06T 7/20; G06T 9/00; G06V 10/60; G06V 10/751; G06T 2207/20221

(57) ABSTRACT

Systems, apparatus, and methods for post-processing video e.g. frame denoising. Noise reduction techniques may be employed to improve the quality of digital video. Frames may be extracted from a video. Synthetic frames may be created using motion data between the extracted frames. Synthetic frames may be masked to exclude pixels from the composite frame. Thresholds used in masking may vary based on the temporal distance of the extracted frame used to create the synthetic frame and the extracted frame. Masking may be based on frame differences between extracted and synthetic frames (e.g., sub-pixel/luminance differences), areas of lower quality motion data (e.g., occlusions), or edge detection in the extracted frames. Synthetic and extracted frames may be composited generating frames having less noise. The composited frame may be based on averaging pixel values across the synthetic and extracted frames. Composited frames may be compiled and encoded into denoised video.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of digital image capture and post-processing. More particularly, the present disclosure relates to methods and apparatus for frame denoising.

### DESCRIPTION OF RELATED TECHNOLOGY

Digital cameras have sensors that convert light into electronic signals. Noise is introduced into video due to various conditions. For example in low-light conditions, sensors struggle to capture enough light, resulting in noise. This noise appears as random specks of color or brightness variations in the video. Increasing the ISO setting on a camera makes the sensor more sensitive to light, allowing for better low-light performance. However, this also amplifies the sensor's noise, resulting in grainier footage.

“Color noise” or “chroma noise,” is one type of digital noise that occurs when random specks of color appear in video footage, especially in low-light conditions or areas with uniform colors like shadows or dark regions. The presence of color noise can result in color popping effects in video. This type of noise is most noticeable in areas of uniform color, such as shadows or flat surfaces, and can be especially distracting in dark scenes.

Denoising solutions can blur fine details and textures, making the image or video appear overly smooth. Other solutions may introduce artifacts (e.g., banding, smudging) or ghosting effects.

### BRIEF DESCRIPTION OF THE DRAWINGS

FIG. 1 is a graphical representation of a frame generation and stacking technique for reducing noise in digital video according to aspects of the present disclosure.

FIG. 2 illustrates an exemplary logical flow diagram of a frame denoising technique according to aspects of the present disclosure.

FIG. 3 is a graphical representation of a frame generation and stacking technique for reducing noise in digital video according to aspects of the present disclosure.

FIG. 4 is a directory structure for frame denoising according to aspects of the present disclosure.

FIG. 5 is an exemplary composite frame without the use of occlusion masking.

FIG. 6 is an occlusion map useful in illustrating aspects of the present disclosure.

FIG. 7 is an exemplary composite frame generated using occlusion masking according to aspects of the present disclosure.

FIG. 8 is an exemplary frame of video useful to illustrate aspects of the present disclosure.

FIG. 9 is an exemplary edge mask of the exemplary frame of video illustrated in FIG. 8.

FIG. 10 illustrates two versions of a portion of an exemplary composite frame useful to illustrate aspects of the present disclosure.

FIG. 11 is a logical block diagram of the exemplary system architecture, in accordance with various aspects of the present disclosure.

FIG. 12 is a logical block diagram of an exemplary capture device, in accordance with various aspects of the present disclosure.

FIG. 13 is a logical block diagram of an exemplary post-processing device, in accordance with various aspects of the present disclosure.

FIG. 14 is an exemplary frame of video useful to illustrate aspects of the present disclosure.

FIG. 15 is an exemplary composite frame of video useful to illustrate aspects of the present disclosure.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

According to an exemplary aspect of the present disclosure, noise reduction techniques may be employed to improve the quality of digital video. Synthetic frames may be created using motion data between frames of video data and may mimic frames of video data. Synthetic and captured/extracted frames are composited (e.g., stacked, averaged, weighted averaged, etc.) creating new frames having less noise. Additional quality improvements may be achieved by masking portions of the synthetic frame data used in creating the composite frame. In some examples, differences between synthetic and captured frames are compared and pixels below a threshold are used to generate composite frames and pixels above the threshold those pixels are not used to generate composite frames.

In other examples, in areas of the frame with occlusions (or other anomalies that may impact optical flow estimation), areas having occlusions may be masked (and therefore excluded) from the stacked/averaged frame. In other examples, areas of defined edges in an extracted frame may be masked in a synthetic frame. Edge masks may allow for sharper edges for features in the resulting composite frame.

More broadly, aspects of the present disclosure relate to post-processing techniques. While many of the examples are described as a technique to remove noise (and chromatic noise), the system, apparatus, and methods described herein may be used to reduce/remove other anomalies from video. Other anomalies may include flicker, compression artifacts, auto exposure differences/changes, and artifacts in stereoscopic video. Accordingly, the present disclosure includes techniques for performing deflickering, reducing compression artifacts, auto exposure smoothing, and reducing artifacts in stereoscopic video.

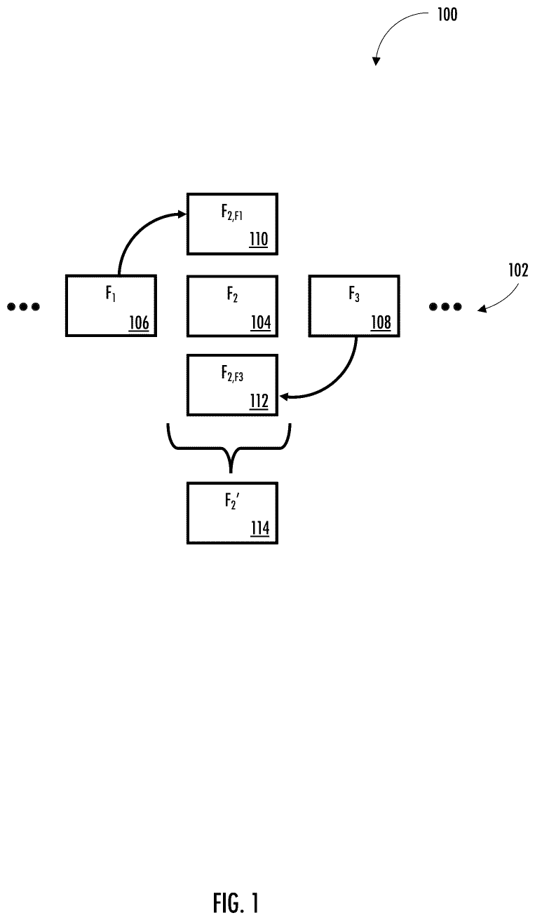

FIG. 1 is a graphical representation 100 of a frame generation and stacking technique for reducing noise in digital video according to aspects of the present disclosure. A video 102 including a sequence of frames (F₁-F₃) is shown. A current frame 104 (F₂), within the video 102 has two temporal neighboring frames 106 (F₁) and 108 (F₃). Data from neighboring frames 106 (F₁) and 108 (F₃) may be used to reduce/remove noise in the current frame 104 (F₂). In some examples, neighboring frames may be warped to mimic the current frame by creating synthetic frames 110 (F₂, F₁) and 112 (F₂, F₃) of the current frame 104 (F₂). Synthetic frames 110 (F₂, F₁) and 112 (F₂, F₃) may be combined with the current frame 104 (F₂) to create a composite frame 114 (F₂′).

Optical flow analysis may be performed on the video/series of frames to determine the movement of pixels from one frame to the next. Optical flow analysis is a technique used to estimate the motion of objects, surfaces, or points between consecutive frames in a sequence of images, frames, or video (e.g., video 102). Optical flow may be calculated in the forward direction from neighboring frame 106 (F₁) to current frame 104 (F₂) and from current frame 104 (F₂) to neighboring frame 108 (F₃). Optical flow may be calculated in the reverse direction from neighboring frame 108 (F₃) to current frame 104 (F₂) and from current frame 104 (F₂) to neighboring frame 106 (F₁).

Optical flow may involve analyzing the apparent movement of brightness patterns in the frame to determine the direction and speed of motion. Motion vectors may represent the movement of pixels from one frame to the next. Each vector indicates the direction and magnitude of the movement. In some examples, optical flow assumes that the brightness of a point/pixel remains constant (or substantially constant, e.g., within +/−5%) over time as it moves. Spatial and temporal gradients of image intensity may be calculated to estimate motion. The spatial gradient measures the change in intensity across the image, while the temporal gradient measures the change in intensity over time.

Various optical flow techniques may be used. For example, differential methods may be used. In the Lucas-Kanade Method, a post processing device performs local search using a set of neighboring pixels to solve for the motion vectors. In the Horn-Schunck Method, a smoothness constraint may be used that assumes the flow is smooth across the image, a post-processing device may solve for the motion vectors by minimizing an energy function that combines the brightness constancy and smoothness constraints. In other examples, block matching techniques may be used. In such techniques, the frame may be divided into blocks and the post-processing device may find the best matching block in the subsequent frame using similarity measures such as sum of absolute differences (SAD) or sum of squared differences (SSD). In further examples, feature-based methods may be used to detect distinctive features (e.g., corners, edges) in the frame and track the feature movement across frames. In other examples, phase-based methods analyze the phase information of frame signals to estimate motion. Combinations of these described techniques may be used.

The optical flow analysis may generate a set of motion vectors (e.g., a motion field) indicating the displacement of each pixel from one frame to the next. Each pixel in a first frame (e.g., neighboring frame 106 (F₁) has a corresponding motion vector (u, v). These vectors represent the horizontal (u) and vertical (v) displacement of each pixel to its new position in the next frame (e.g., current frame 104 (F₂).

Where there is a large amount of motion, occlusions, and/or lighting differences between frames, rather than attempting to calculate the optical flow the optical flow is not calculated and is cut short. In some cases, synthetic frames generated where there are large differences between frames (e.g., large amount of motion, occlusions, and/or lighting differences) may not aid in noise reduction and may in fact be counter-productive and add additional noise when combined in a composite frame. Synthetic frames may not be generated where the optical flow is not completed or where a large amount of motion, occlusions, and/or lighting differences between frames is detected. Composite frames (e.g., composite frame 114 (F₂′)) may be generated by not including (e.g., ignoring) this missing/not generated data.

In other examples, other techniques of motion detection is used instead of or in combination with optical flow. As one illustrative example, synthetic frames may be created using linear frame interpolation that uses the temporal relationship between frames to interpolate pixel location. For example, the pixel location for an interpolated frame that is midway between frames 106 (F₁) and 108 (F₂) may be at a distance that is half the distance from the pixel locations in frames 106 (F₁) and 108 (F₂). This motion information may be used to generate synthetic frames. Non-linear frame generation techniques may perform motion estimation and/or model object motion using higher-order motion estimation (e.g., acceleration, etc.). The processing power and memory required for non-linear frame interpolation typically scales as a function of its underlying algorithm, e.g., motion estimation based on a polynomial would scale according to its polynomial order, etc. Currently, non-linear frame interpolation is infeasible for most embedded applications, however improvements to computing technologies may enable such techniques in the future. Other frame interpolation techniques may rely on neural network processing/artificial intelligence (AI) models for computer vision applications. Such techniques attempt to infer intermediate frames based on previous libraries of training data, etc. Still other approaches use more esoteric algorithms; for example, a single convolution process to perform motion estimation or generating multiple synthetic versions of the current frame in a single step.

Another technique for performing/improving motion estimation is incorporating a depth map that contains information relating to the distance of the surfaces of scene objects from the camera (“depth” refers to the third (or fourth) dimension, commonly denoted as the Z-direction). This information can be used to improve synthetic pixels as they are revealed/occluded. This depth information can also be used to provide occlusion data to generate an occlusion mask for application onto synthetic frames prior to compositing with the current frame 104 (F₂).

Using optical flow information (e.g., motion vectors), synthetic frames (e.g., synthetic frames 110 (F₂, F₁) and 112 (F₂, F₃)) may be generated by moving pixels in a frame. Synthetic frame generation may be forwards or backwards temporally, depending on whether the optical flow information is used in time or in reverse time.

To generate a synthetic frame (e.g., synthetic frames 110 (F₂, F₁) and 112 (F₂, F₃)), a frame (e.g., neighboring frames 106 (F₁) and 108 (F₃)) may warped based on the optical flow. Warping a frame using optical flow may include transforming one frame (e.g., neighboring frames 106 (F₁) and 108 (F₃)) in a video sequence to align with another frame (e.g., current frame 104 (F₂)) based on the estimated motion vectors generated during the optical flow analysis. Backward/inverse warping may be used. Backward warping may include transforming one frame (e.g., neighboring frames 108 (F₃)) back to its original position in another frame (e.g., current frame 104 (F₂)) based on the estimated motion vectors generated during the optical flow analysis.

Pixel positions in the resulting frame (e.g., the current frame 104 (F₂)) may not map exactly to integer coordinates in the original frame (e.g., neighboring frames 106 (F₁) and 108 (F₃)). Frame interpolation techniques (e.g., bilinear interpolation) may be used to estimate the pixel values at non-integer coordinates.

Composite frames (e.g., composite frame 114 (F₂′)) may be generated by combining the current frame 104 (F₂) and synthetic frames 110 (F₂, F₁) and 112 (F₂, F₃). In some examples, the composite frame 114 (F₂′) may be generated by taking an average of the frames. For example, an average frame may be generated by combining multiple frames by averaging the pixel values at each position. An accumulator may record the sum of the pixel values at the same position in the frames being averaged (e.g. current frame 104 (F₂) and synthetic frames 110 (F₂, F₁) and 112 (F₂, F₃)). The average pixel value may be calculated by dividing the accumulated pixel values by the number of images to get the average pixel value at each position of the composite frame 114 (F₂′).

Other weighting schemes (rather than a simple average) can be used to generate the composite frame 114 (F₂′). In one implementation, the sum/weighing allocates the highest weight to pixels in the current frame 104 (F₂) and lower weights to pixels from synthetic frames 110 (F₂, F₁) and 112 (F₂, F₃)). In some examples, where multiple levels of neighboring frames are used, the highest weight may be given to pixels in the current frame 104 (F₂) and lower weights to pixels from synthetic frames 110 (F₂, F₁) and 112 (F₂, F₃) from neighboring frames 106 (F₁) and 108 (F₃) and even lower weights to pixels from synthetic frames generated from more distantly neighboring frames. In other examples, pixels may be weighted based on the amount of motion, occlusions, and/or lighting differences detected between the neighboring frames 106 (F₁) and 108 (F₃) and the current frame 104 (F₂). Various other weighting schemes may be substituted with equal success.

Once the current frame 104 (F₂) has been composited, generating composite frame 114 (F₂′), the denoising process for the current frame 104 (F₂′) may be run on the composite frame 114 (F₂′) to generate a double-denoised frame. If there is a next frame in the series of frames, the post-processing device may continue to generate a composite frame for the next frame (e.g., F₃, etc.). Once all frames are composited, the composited frames may be compiled and encoded into a video file.

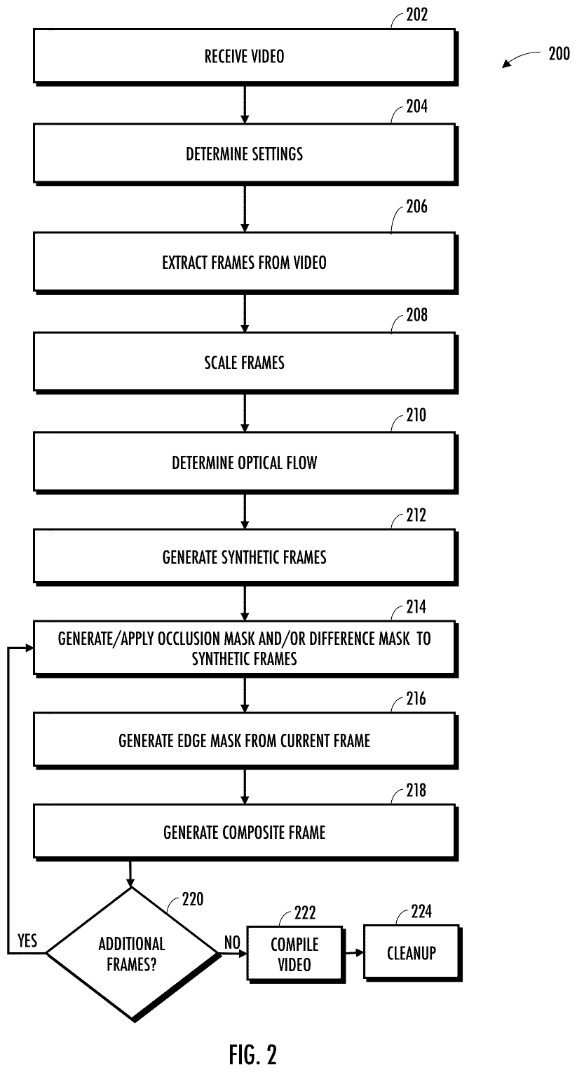

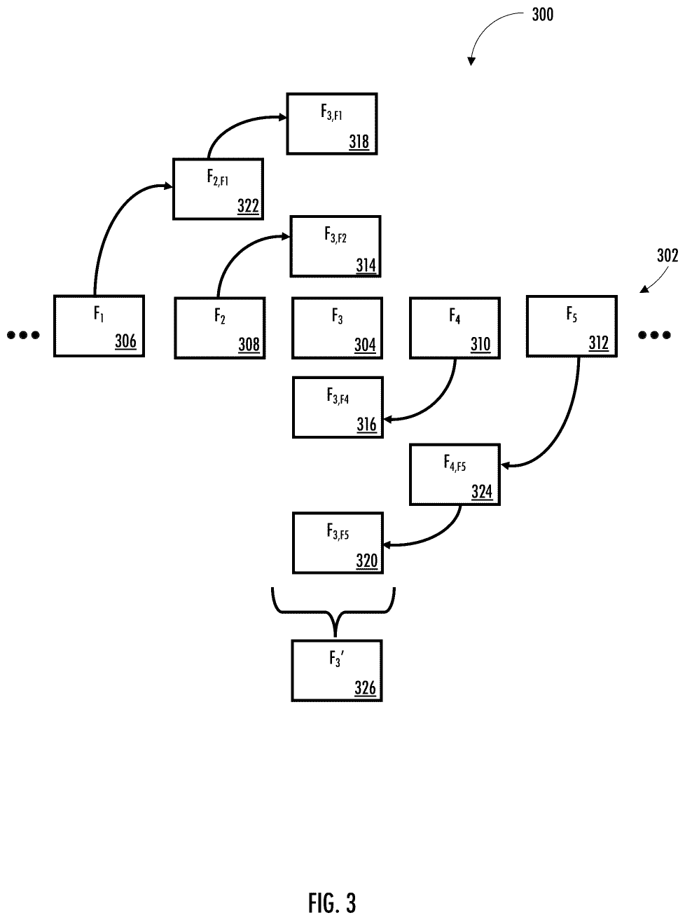

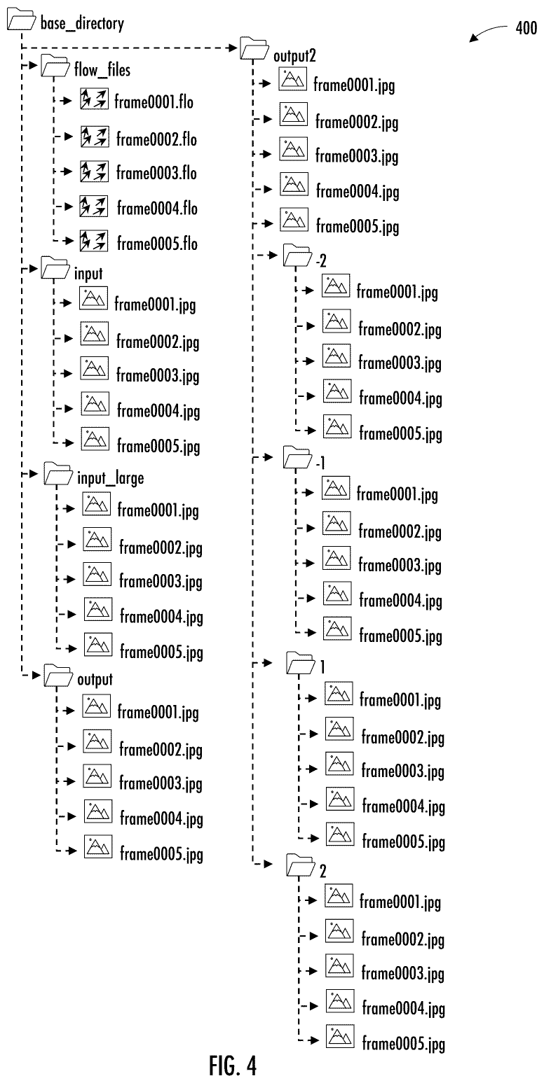

FIG. 2 illustrates an exemplary logical flow diagram of a frame denoising technique 200 according to aspects of the present disclosure. The steps may be performed either by processing systems in a camera and/or by one or more separate post-processing devices. FIG. 3 is a graphical representation 300 of a frame generation and stacking technique for reducing noise in digital video. A video 302 including a sequence of frames (F₁-F₅) is shown. FIG. 4 is a directory structure 400 for frame denoising according to aspects of the present disclosure. The frame denoising technique 200 may create and use the directory structure 400 for storing temporary files created as part of the denoising process. Temporary files may include extracted frames, scaled extracted frames, flow files, synthetic frames, and composited frames. The directory structure 400 is a base directory with an input folder, an input_large folder, an output folder, and output2 folder. In some examples, inside the base directory folder is also an output3 folder. Inside the output2 (and, in some examples, output3) folders are the −2, −1, 1, and 2 subfolders. The subfolders within the output2 may correspond to the number of iterations (in this example: 2) of synthetic frames that are generated.

Video may be received by a (post)-processing device (at step 202). In some examples, the received video is captured by the device. In other examples, video may be received from a camera or other device may be transferred to a post-processing device to remove noise. The video may be transferred via a removable storage media such as a memory card or a data/network interface (wired or wireless).

The video 302 may include a sequence of frames (F₁-F₅). A current frame 304 (F₃), within the video 302 has four temporal neighboring frames 306-312 (F₁, F₂, F₄, and F₅). Two of the neighboring frames 306 and 308 (F₁ and F₂) are temporally before the current frame 304 (F₃), and two neighboring frames 310 and 312 (F₄ and F₄₅) are temporally after the current frame 304 (F₃). Data from neighboring frames 306-312 (F₁, F₂, F₄, and F₅) may be used to reduce/remove noise in the current frame 304 (F₃). In some examples, neighboring frames may be warped to mimic the current frame by creating synthetic frames 314-324 (F₃, F₂, F₃, F₄, F₃, F₁, F₃, F₅, F₂, F₁, and F₄, F₅). Synthetic frames 314-320 (F₃, F₂, F₃, F₄, F₃, F₁, and F₃, F₅) of the current frame 304 (F₃) may be combined with the current frame 304 (F₃) to create a composite frame 326 (F₃′). Synthetic frames 322 (F₂, F₁) and 324 (F₄, F₅) may be used to create synthetic frames 318 (F₃, F₁) and 320 (F₃, F₅), respectively. Synthetic frames 322 (F₂, F₁) and 324 (F₄, F₅) may also be used directly (rather than, e.g., as an intermediary) in calculating a composite frame for frames 308 (F₂) and 310 (F₄), respectfully.

The post-processing device may determine noise reduction settings (at step 204). Settings may be determined based on user input, system settings (e.g., default locations), resource availability and constraints (e.g., memory, processing power, a real-time budget, etc.), etc. Other settings may include a location (e.g., directory/path and filename) of the original video and/or series of images, and a location (e.g., directory/path and filename) of the denoised video and/or series of frames. Settings may further include whether to perform a second (e.g., double) denoising step to the video 302. Other settings may include quality/compression settings of the composite images, the re-encoded video, scaling frame resolution for optical flow, the motion detection algorithm/optical flow performed, etc.

Noise reduction settings may also include the number of iterations (e.g., 1-10) of synthetic frames to generate and composite. The number of iterations may be based on the number of neighboring frames (on each side) of the current frame in the video used to generate synesthetic frames. The number of iterations may impact the number of synthetic frames that are generated that mimic each of the frames of the sequence of frames (F₁-F₅) of video 302. For example, neighboring frames 308 (F₂) and 310 (F₄) are at a first iteration, and neighboring frames 306 (F₁) and 316 (F₅) are at a second iteration. Additional settings may include one or more (e.g., two, three, four, etc.) thresholds for creating and applying masks (e.g., difference masks). Masks may be applied on a pixel or whole frame basis. Different mask thresholds may be applied based on the iteration level. For example, a lower threshold may be used for pixels in lower iterations and a higher threshold may be used for pixels in higher iterations. This may result in a greater number of pixels from temporally closer frames (e.g., at lower iteration) and fewer pixels from temporally distant frames (e.g., at a higher iteration). In an alternative example, a higher threshold may be used for pixels in lower iterations and a lower threshold may be used for pixels in higher iterations.

At step 206, the post-processing device may extract frames (including frames 304-312 (F₁-F₅)) from the video 302. Extracting frames may include decoding the video file and saving individual frames as separate image files. Frames may be extracted using various tools and libraries such as OpenCV (Open Source Computer Vision Library), a computer vision and machine learning software library for Python, and/or FFmpeg, a suite of libraries and programs for handling video, audio, and other multimedia files and streams including a command-line tool. Extracted frames may be saved to an “output” directory.

At step 208, the post-processing device may scale the extracted frames (including frames 304-312 (F₁-F₅). The scaled frames may be down sampled to perform optical flow on less data. In some examples, the frames are re-extracted from the video 302. In some examples, the scaling is to a 512×288 pixel frame. Scaled frames may be saved to an “input” directory.

The post-processing device, at step 210, may perform an optical flow analysis on the frames. In one example, the post-processing device uses scaled frames. In other examples, the post-processing device uses larger or original frames to perform optical flow analysis. The post-processing device may generate motion vectors from the frames. In one exemplary embodiment, optical flow analysis tracks the movement of pixels, blocks, or identified objects across a series of frames in the video. Optical flow analysis may be performed in the forward direction (e.g., from frame 306 (F₁) to frame 308 (F₂)), in the reverse direction (e.g., from frame 308 (F₂) to frame 306 (F)), or bi-directionally (e.g., both from frame 306 (F₁) to frame 308 (F₂) and from frame 308 (F₂) to frame 306 (F₁) generating two sets of motion vectors or the motion vector data may be combined (e.g., averaged)). Differences in motion vectors between the forward and reverse directions may be based on the optical flow calculation, object detection, movement between frames, pixel selection, and/or other motion estimation. The result of the optical flow analysis is a set of motion vectors for each pixel, block of pixels, or identified object in a frame. Separate sets of motion vectors may be stored for each frame (or between each frame). The motion vectors may be saved in one or more .flo files in a “flow files” directory.

At step 212, the post-processing device generates synthetic frames using the optical flow (e.g., motion vector) data. The synthetic frames 314-324 (F₃, F₂, F₃, F₄, F₃, F₁, F₃, F₅, F₂, F₁, and F₄, F₅) may be generated by warping/moving the pixel, blocks of pixels, or identified objects according to the corresponding motion vectors. For example, synthetic frame 322 (F₂, F₁) is generated based on “captured” frame 306 (F₁) and motion vector data from frame 306 (F₁) to frame 308 (F₂). Synthetic frame 314 (F₃, F₂) is generated based on “captured” frame 308 (F₂) and motion vector data from frame 308 (F₂) to frame 304 (F₃). Synthetic frame 316 (F₃, F₂) is generated based on “captured” frame 310 (F₄) and motion vector data from frame 310 (F₄) to frame 304 (F₃). In some examples, synthetic frame 316 (F₃, F₂) may be generated by the inverse of the motion vector data from frame 304 (F₃) to frame 310 (F₄). Synthetic frame 324 (F₄, F₅) is generated based on “captured” frame 312 (F₅) and motion vector data from frame 312 (F₅) to frame 310 (F₄). In some examples, synthetic frame 324 (F₄, F₅) may be generated by the inverse of the motion vector data from frame 310 (F₄) to frame 312 (F₅).

Successive/higher order synthetic frames, based on other synthetic frames, may be generated. For example, synthetic frame 318 (F₃, F₁) is generated based on synthetic frame 322 (F₂, F₁) and motion vector data from frame 308 (F₂) to frame 304 (F₃). Synthetic frame 320 (F₃, F₅) is generated based on synthetic frame 324 (F₄, F₅) and motion vector data from frame 310 (F₄) to frame 304 (F₃) (or the inverse of the motion vector data from frame 304 (F₃) to frame 310 (F₄).

Synthetic frames may be generated in a forward direction (using forward motion vector data), in a reverse direction (using reverse motion vector data or inverse forward motion vector data), or bi-directionally (using both forward and reverse motion vector data). In some examples, multiple versions of synthetic frames are generated, one from the forward direction and one in the reverse direction. For example, as shown, frame 322 (F₂, F₁) is generated using frame 306 (F₁) and forward motion vector data from frame 306 (F₁) to frame 308 (F₂). Another similar version of the same frame (a different synthetic version of frame 308 (F₂) may be generated using frame 304 (F₃) and reverse motion vector data from frame 304 (F₃) to frame 308 (F₂) (or inverse motion vector data from frame 308 (F₂) to frame 304 (F₃)). In various examples, one, some, or all of these versions of synthetic frames are generated and used to generate composite frames (e.g., frame 326 (F₃′).

Generating synthetic frames may include pixel/object data that includes occlusion data, where pixels, blocks of pixels, or identified objects are obscured by another object and revealed in successive frames. The problems of occluded pixels may be exacerbated where higher iterations (e.g., >1) are used. This is because higher order synthetic frames (e.g., frames 318 (F₃, F₁) and 320 (F₃, F₅)) are generated, based on other synthetic frames (e.g., frames 322 (F₂, F₁) and 324 (F₄, F₅)). In such cases, the optical flow analysis (performed in step 210) may be less precise, include more errors, ghosting effects, etc. Different synthetic frame generation schemes may handle occlusions differently. For pixels and/or indivisible units of the image, the occlusion/reveal may be based on an approximation. Thus, a pixel may be completely occluded in frame 322 (F₂, F₁) (rather than partially occluded), and completely revealed in frame F₃, F₁ (rather than partially occluded). Alternatively, these portions may be weighted and summed (e.g., treated as semi-transparent). For example, a pixel block that is fully occluded in frame 306 (F₁) may be partially occluded in frame 322 (F₂, F_{1.1}) and fully revealed in frame 318 (F₃, F₁), etc.

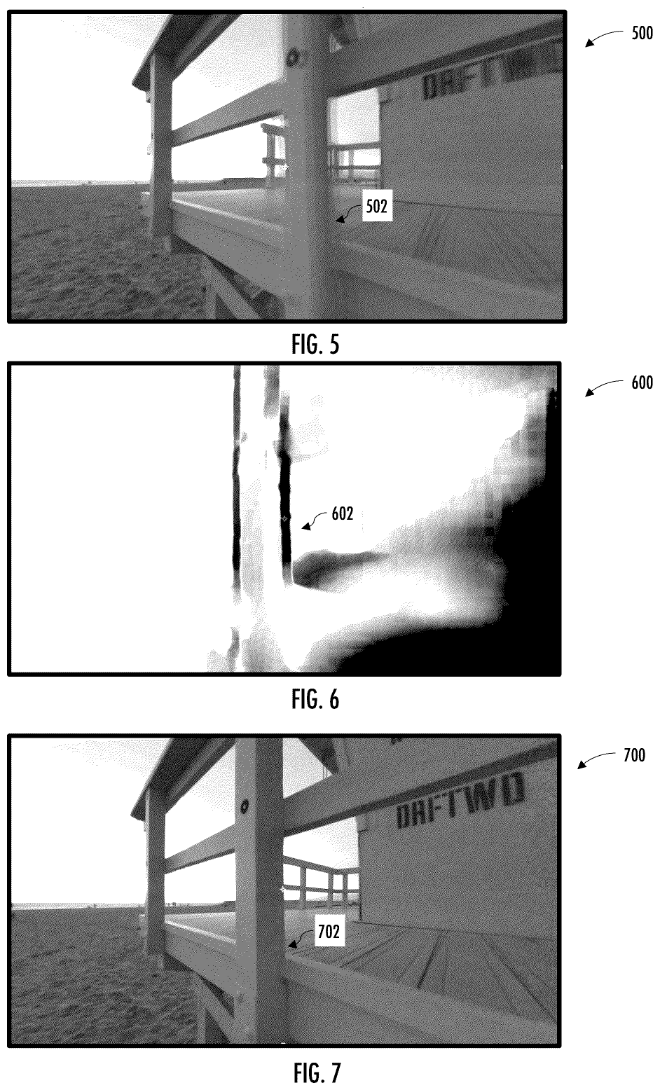

FIG. 5 is an exemplary composite frame 500 without the use of occlusion masking. While areas of noise are reduced, ghosting is present creating a blurred effect in the composite frame, particularly in regions around the post 502. An occlusion map may indicate areas of occlusion or potential occlusion in the frames.

Occluded motion may be determined in a frame (or between frames) of the video. For example, the post-processing device may determine the edges of the optical flow/motion data in a frame to determine contrasting motion. Machine learning (ML) techniques may also be used to estimate occluded motion within a frame (or between frames) of a video (e.g., video 302) following or as part of the determination (or estimation) of motion in a frame/between frames (at step 210).

In one example, amount of motion between consecutive frames of a video may be used to infer occlusions. A directional score may be calculated using the optical flow analysis based on a sum of the absolute magnitude of the motion vectors, and a sum of the directional motion vectors with direction within blocks/regions of the synthetic frame. Large discrepancies between absolute and directional sums would indicate non-uniform directionality (high contrasting motion); whereas both proportionally sized absolute and directional sums would indicate low contrast movement. Areas/regions/blocks of high contrasting motion may be assumed to have occlusions and therefore may be masked (e.g., not included in the final composite frame).

Metadata accompanying the video may be used to infer the amount of motion based on sensors and/or capture parameters. For example, an action camera may have a set of accelerometers, gyroscopes, and/or magnetometers that can be used to directly measure motion of the camera. In addition, the camera exposure settings may be used to determine lighting conditions, frame rate, etc. These factors can be used in combination to determine whether motion would likely experience ghost artifacts during synthetic frame generation. Additionally, in-camera processing (e.g., facial recognition, object recognition, motion compensation, in-camera stabilization, etc.) may be used to identify capture scenarios that may indicate disparate treatment/non-inclusion in the final composite frame. For example, a rapidly moving “face” against a background, or vice versa, could be susceptible to e.g., foreground/background artifacts.

Capture/in-camera metadata may also improve the optical flow analysis. For example, in-camera stabilization results may be used to infer the camera motion, and by extension, motion in the frames. Exposure settings may be used to determine the shutter speed/angle during capture, etc. This information may be useful in combination with optical flow analysis to infer the amount of motion with greater precision.

In some examples, an edge detection technique may be used to determine areas of occluded motion. An edge map may be generated from the optical flow/motion data based on a greater than a threshold amount of change in motion (depicted as brightness in a visual representation; discontinuities more generally).

One or more edge detection techniques may be used to determine occlusions/occluded motion via the creation of an edge map. For example, contrasting motion may be determined via edge detection on motion vectors/motion vector magnitudes.

The post-processing device may build an occlusion map to determine occlusions. An occlusion map is a map showing regions of occlusion in a frame. An occlusion map may be used to estimate a region of occluded motion in the frame. The occlusion map may indicate pixels/objects of a frame that do not have a corresponding pixel/object in the subsequent (or previous) frame. Use of an occlusion map over an edge map may more accurately determine the amount of space each occlusion occupies of a frame compared to an edge map which may indicate the occurrence of occlusions in an area.

In some examples, a device may perform depth estimation to estimate the depth or distance for each pixel or a selection of pixels (or objects/features) in frames of video. Some techniques for performing depth estimation include structure-from-motion and machine learning models. Occlusions may be detected based on analyzing depth discontinuities based on the depth estimation. Occlusions may also be detected based on information in neighboring frames. An occlusion map may be generated based on the detected/estimated occlusions. Occlusion information may then be propagated for use in other frames of the video. This may help maintain temporal coherence/consistency across frames which may ensure smooth transitions in the interpolated video. Smoothing, noise reduction, or other operations may also be performed on the occlusion map to improve usability and performance.

FIG. 6 is an occlusion map 600 useful in illustrating aspects of the present disclosure. The occlusion map may indicate areas (pixels, blocks, regions, objects) that should not be composited with synthetic frames. This may be because the benefits of noise reduction may be outweighed by the ghosting/blurring from the compositing of pixels/areas with occlusions. Using an edge detection technique, occlusion map 600 was generated to illustrate motion between frames which may indicate areas of contrasting/occluded motion. In the occlusion map 600, light colored/white pixels (or low values) indicate areas of no/low occluded motion and dark colored/black pixels (or high values) indicate areas of occluded motion (or high occluded motion). Notice occlusion map 600 indicates an area of high motion/occlusions at the edges of the post 602 shown with a dark outline.

An occlusion mask may be generated by the post-processing device (at step 214). In some examples, an occlusion mask may be generated from an occlusion map by applying a threshold cutoff (e.g., 15%) for pixel inclusion or exclusion from the final composite frame. In this example, the occlusion mask is constructed of binary values indicating inclusion in the final composite frame (e.g., 1 for values showing motion below the threshold) and exclusion from the final composite frame (e.g., 0 for values showing motion above the threshold). The threshold value may be set to a default value or to a value that the user may select/adjust (e.g., in the settings determined at step 204). In some cases, the threshold value may also balance other aspects of post-processing operation—for example, devices with processing, memory, or power limitations may have a “floor” to ensure that rendering remains within device capabilities. This may be particularly useful in mobile and embedded devices (e.g., post-processing on a smart phone, etc.) where device resources are limited.

Additionally, the post-processing device may generate a difference mask to determine differences between pixel values (or sub-pixel values) between a synthetic frame and the current frame (e.g., frame 304 (F₃)). The post-processing device may calculate the difference between pixel(s) in the synthetic frame and the corresponding pixel(s) in the current frame. The difference (or a component of the difference) may be compared with a threshold to generate a difference mask. In some examples, a luminance component (or a grayscale conversion) of the differences between pixels/blocks/regions of the synthetic and current frames may be compared with the threshold to generate the difference mask. For example, the luminance component of the difference being above a threshold, may indicate occlusions, other problems with optical flow/motion detection, other anomalies, etc. Comparing only the luminance components of the pixels of the synthetic frame and current frame may allow (e.g. large) chrominance differences to not be masked. These chrominance differences may be due to color/chroma noise which would then be reduced via later compositing.

In some examples, the difference threshold may vary based on the iteration (e.g., 1-10) of the synthetic frame (e.g., 1, 2, 3, 4, etc.). For example, a user may indicate multiple (e.g., 4) threshold difference values (as determined in step 204). In some examples, the difference threshold may be higher for lower iterations (e.g., synthetic frames generated based on “original” frames temporally closer to the current frame) and lower for higher iterations (e.g., synthetic frames generated based on “original” frames temporally distant to the current frame). In other words, pixels of synthetic frames generated based on “original” frames that are temporally closer to the current frame may be more accepting of differences (e.g., are weighted more favorably/higher) than synthetic frames generated based on “original” frames that are temporally more distant to the current frame. In such examples, user input may be constrained to meet this criterion. For example, a user may be disallowed from selecting/inputting a threshold difference for a second iteration/group of iterations that is lower than a first iteration/group of iterations.

The occlusion mask and difference mask may be combined into a combined mask. In some examples, where either mask would exclude a pixel/block/region of the synthetic pixel, the combined mask would exclude the pixel. In other examples, where either mask would include a pixel/block/region of the synthetic pixel, the combined mask would include the pixel. In further examples, a multi-variable threshold formula is used that combines both occlusion and difference values to generate the combined mask.

In some examples, entire frames (or regions of frames) may be excluded/“masked out” when the number/percentage of excluded pixels/blocks is above another threshold (e.g., 50%).

The occlusion mask, the difference mask, and/or the combined mask may be applied to the synthetic frame(s) (generated in step 212). In some examples, pixel values of the synthetic frame may be multiplied by the mask value (0 or 1) to generate a masked synthetic frame. An inclusion counter may provide pixel/block-wise tracking of how many pixels will be ultimately combined to create the final composite frame. The inclusion counter for a pixel may be incremented when the corresponding pixel in the masked synthetic frame is included in the final composite frame (e.g., where the mask value of the pixel equals 1).

FIG. 7 is an exemplary composite frame 700 generated using occlusion masking. Compared with exemplary composite frame 500 (of FIG. 5), the ghosting/blurring present in the exemplary composite frame 500 is absent in the masked exemplary composite frame 700. This is most notable in regions around the post 702.

At step 216, an edge mask may be generated by the post-processing device. The edge mask may indicate edges of the current frame. Small (even sub-pixel length) differences in edge alignment (due to errors in optical flow) between the current frame and a synthetic frame or compression artifacts in the synthetic frame may appear to reduce the sharpness/clarity of a composited frame. These small differences may be exacerbated when the number of frames composited increases.

The post-processing device may perform edge detection on the current frame 304 (F₃). As a brief aside, edge detection techniques are commonly used in image processing and computer vision to identify and extract the boundaries or edges of objects within an image. These techniques help to locate sharp changes in intensity or color values, which typically correspond to object boundaries.

One category of edge detection are gradient-based methods. These techniques detect edges by computing the gradient (rate of change) of intensity values in the image. The gradient represents the direction and magnitude of the change in intensity. Common gradient-based methods include the Sobel operator/filter, Prewitt operator, and Roberts operator. The Sobel operator/filter calculates the gradient using a set of convolutional filters in the horizontal and vertical directions and highlights edges by emphasizing regions with high intensity gradients. The magnitude represents the strength of the edge, while the orientation indicates the direction of the edge. The Prewitt operator uses two convolutional filters to compute the horizontal and vertical gradients. It is also effective in detecting edges. The Roberts operator approximates the gradient by computing the squared differences between neighboring pixels in diagonal directions.

Another set of edge detection techniques are Laplacian-based. Laplacian-based methods detect edges by identifying zero-crossings in the second derivative of the image. The Laplacian operator highlights regions of the image where the intensity changes abruptly. Laplacian-based techniques may be sensitive to noise and may use additional processing to suppress false edges. Further edge detection techniques include edge linking and boundary tracing techniques. These techniques aim to connect edge pixels to form continuous curves or contours. One common approach is the use of the Hough transform, which detects lines and curves by representing them in a parameter space and finding the peaks in that space.

A further edge detection technique is the Canny edge detector. The Canny algorithm is a multi-stage edge detection method used for its high accuracy and low error rate. To perform edge detection using the Canny algorithm, the device may perform: smoothing by convolving the image (e.g., of optical flow) with a Gaussian (or other) filter to reduce noise; computing gradients in the horizontal and vertical directions using derivative filters; suppressing non-maximum gradient values by keeping local maximum gradient values to thin out the edges and preserve the finer details; and performing hysteresis thresholding which may include a double thresholding technique to determine strong and weak edges. Weak edges that are connected to strong edges may be considered as part of the edge structure.

Machine learning techniques may also be used for edge detection. Artificial neural networks to learn and predict edges in images. These techniques may learn edge detection from a large dataset of labeled images. For example, a Convolutional Neural Networks (CNN) architecture may be used that includes multiple convolutional layers which automatically learn and extract hierarchical features from input images. By training the network on a large dataset of images with labeled edges, the CNN may learn to recognize and localize edges based on the patterns and relationships discovered during training. Fully Convolutional Network (FCN) architectures may also be used to perform edge detection. FCNs preserve the spatial information of the input image throughout the network, allowing for precise localization of edges. FCNs may employ encoder-decoder architectures, where the encoder extracts features from the input image, and the decoder upsamples the features to produce a dense output map representing the edges. U-Net architectures may include an encoder pathway and a decoder pathway that gradually upsamples features and combines them with skip connections. The U-Net architecture may enable the device to capture both local and global contextual information, aiding accurate edge localization. Other ML architectures and techniques may be used to perform edge detection such as Conditional Random Fields (CRFs) and Generative Adversarial Networks (GANs).

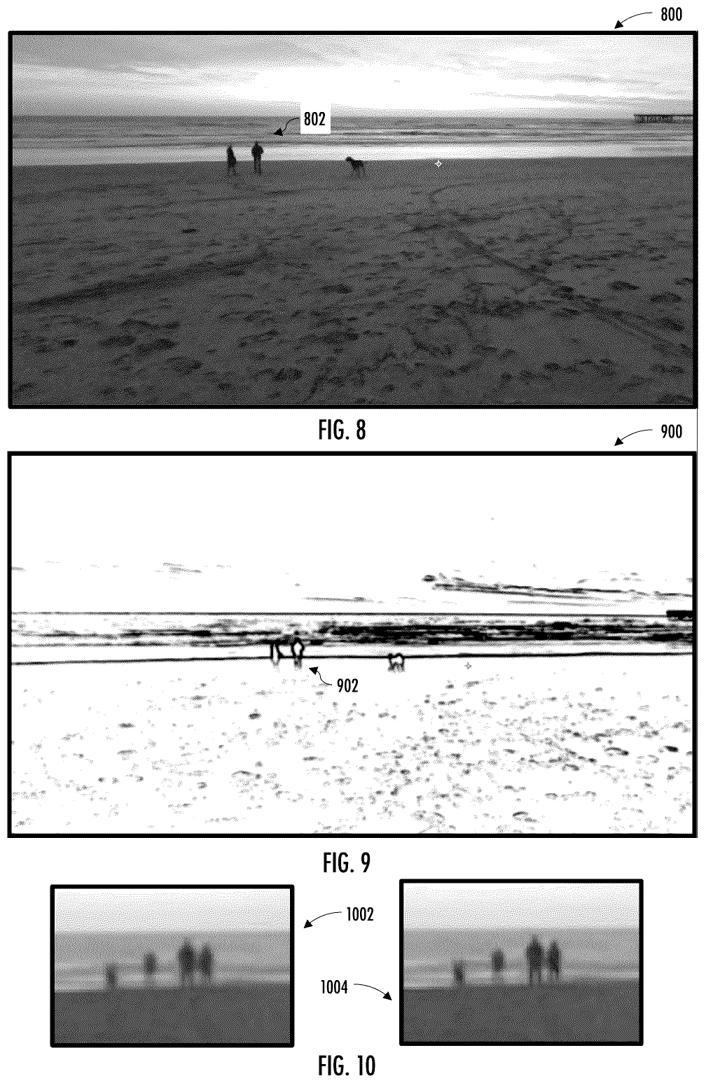

FIG. 8 is an exemplary frame of video 800 useful to illustrate aspects of the present disclosure. FIG. 9 is an exemplary edge mask 900 of the exemplary frame of video 800 illustrated in FIG. 8. As illustrated, the exemplary edge mask 900 indicates areas of high contrast. In the exemplary edge mask 900, light colored/white pixels (or low values) indicate areas of no/low contrast indicating the lack of the presence of an edge and dark colored/black pixels (or high values) indicate areas of high contrast indicating the presence of an edge. The people 802 in the exemplary frame of video 800 are in a relatively highly contrasting against the water in the background. This area of contrast, indicating an edge, is illustrated by the outline around the people 902 in the exemplary edge mask 900.

An edge mask may be generated by the post-processing device. Unlike the occlusion/difference masks applied to the synthetic frames (individually), pixels of all synthetic frames may be excluded from the final composite image (as a group) based on the edge mask. In some examples, an edge mask may be generated from an edge map by applying a contrast/edge threshold for synthetic pixel inclusion or exclusion from the final composite frame. In this example, the edge mask is constructed of binary values indicating synthetic pixel inclusion in the final composite frame (e.g., 1 for edge pixels/regions showing high contrast) and exclusion of synthetic pixels from these pixel locations in the final composite frame (e.g., 0 for values showing motion above the threshold). In other words, where the edge mask indicates an edge (e.g., a value of 1), those pixels of the current frame are not composited with synthetic pixels from any synthetic frame. The threshold value (and an edge thickness/dilation value) may be set to a default value or to a value that the user may select/adjust (e.g., in the settings determined at step 204). In some cases, the threshold value may also balance other aspects of post-processing operation—for example, devices with processing, memory, or power limitations may have a “floor” to ensure that rendering remains within device capabilities. This may be particularly useful in mobile and embedded devices (e.g., post-processing on a smart phone, etc.) where device resources are limited.

In some examples, entire current frames may be excluded from compositing where the number/percentage of excluded pixels/blocks/regions is above another threshold (e.g., 50%).

The edge mask may be applied to the synthetic frame(s) (generated in step 212). In some examples, pixel values of the synthetic frame may be multiplied by the mask value (0 or 1) to generate a masked synthetic frame. An inclusion counter may provide pixel/block-wise tracking of how many pixels will be ultimately combined to create the final composite frame. The inclusion counter for a pixel may be incremented when the corresponding pixel in the masked synthetic frame is included in the final composite frame (e.g., where the mask value of the pixel equals 0).

FIG. 9 is an exemplary edge mask 900 of the exemplary frame of video 800 illustrated in FIG. 8. As illustrated, the exemplary edge mask 900 indicates areas of high contrast. In the exemplary edge mask 900, light colored/white pixels (or low values) indicate areas of no/low contrast indicating the lack of the presence of an edge and dark colored/black pixels (or high values) indicate areas of high contrast indicating the presence of an edge. The people 802 in the exemplary frame of video 800 are in a relatively highly contrasting against the water in the background. This area of contrast, indicating an edge, is illustrated by the outline around the people 902 in the exemplary edge mask 900.

FIG. 10 illustrates two versions 1002 and 1004 of a portion of an exemplary composite frame useful to illustrate aspects of the present disclosure. In the first version 1002 of the composite frame no edge mask is applied to synthetic frames before compositing. In the second version 1004 of the composite frame an edge mask is applied to synthetic frames before compositing. As shown, the version 1004 of the composite frame where the edge mask is applied is sharper particular around the people and at the horizon compared with the version 1002 of the composite frame where the edge mask is not applied.

At step 218, the post-processing device may generate the composite frame 326 (F₃′). Once the synthetic frames 314 (F₃, F₂), 316 (F₃, F₄), 318 (F₃, F₁), and 320 (F₃, F₅) have been generated and the masks (e.g., the occlusion, difference, and/or synthetic masks) have been applied, a composite frame 326 (F₃′) may be generated by e.g., summing the (masked) pixel values across the current frame 304 (F₃) and synthetic frames 314 (F₃, F₂), 316 (F₃, F₄), 318 (F₃, F₁), and 320 (F₃, F₅) and dividing by the number of pixels values being composited (e.g., all if all are included/none are masked out, one if they are all masked out/not included apart from the current frame 304 (F₃), or some, if some are masked out including the current frame 304 (F₃)). Conceptually, compositing the frames is analogous to layering multiple opaque and/or semi-transparent frames on top of each other. Pixels included in the composite frame 326 (F₃′) are weighted according to a predetermined level of transparency based on, e.g., the number of frames being combined. In some examples, there is a frame-specific weighting (based on iteration, where the smaller in absolute value the iteration associated with the frame the higher the weight apart from the current frame 326 (F₃′)). Once each of the frames has been weighted, then their pixel values can be summed together and then divided are divided by the number of (non-zero) pixel values included in the composite frame 326 (F₃′).

In one example, combined frames (e.g., the current frame 304 (F₃) and synthetic frames 314 (F₃, F₂), 316 (F₃, F₄), 318 (F₃, F₁), and 320 (F₃, F₅)) may be linearly averaged with each included/unmasked pixel/block/region of each frame receiving the same weight. This may be the visual equivalent to combining the frames at an equal transparency.

In some examples, steps 214, 216, and 218 (and, in some examples, step 212) are combined and each performed for a synthetic frame before performing the steps 214, 216, and 218 (and, in some examples, step 212) on the next frame. In other words, masks are calculated/applied to the pixels of a synthetic frame, an accumulator adds the masked pixel values for each pixel of the synthetic frame, and a counter tracks the number of pixels included in the accumulator before moving on to the next frame.

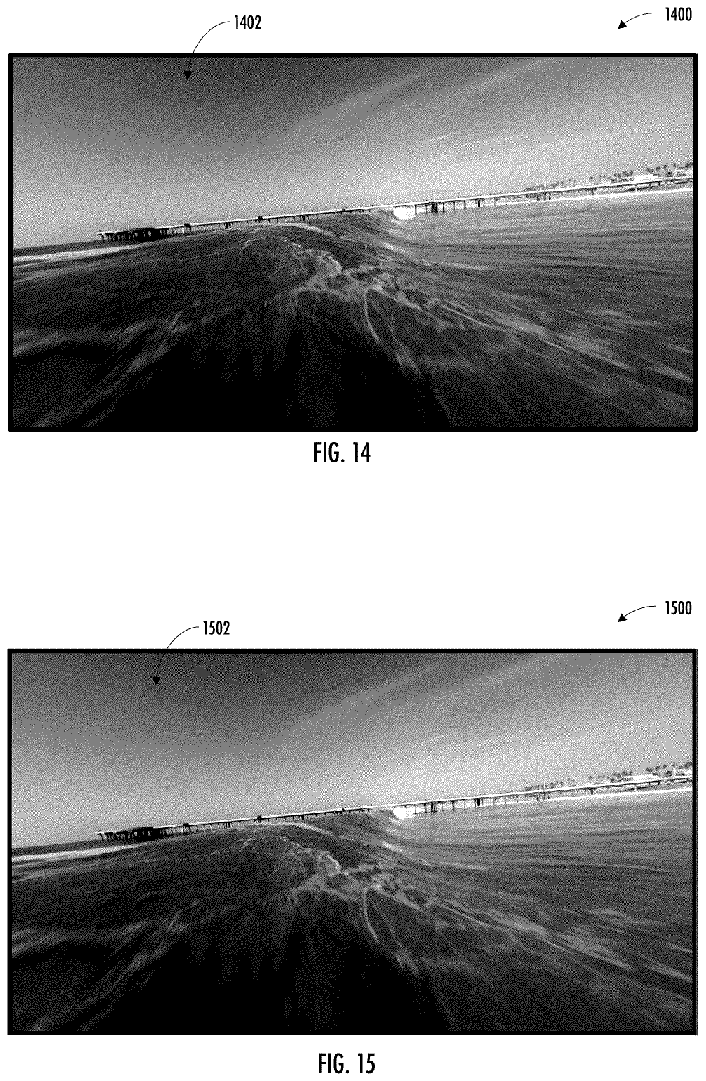

FIG. 14 is an exemplary frame 1400 of video useful to illustrate aspects of the present disclosure. Various anomalies including noise, blocky compression artifacts, flickering effects, and banding are present in frame 1400, particularly noticeable in regions of sky 1402. FIG. 15 is an exemplary composite frame 1500 of video useful to illustrate aspects of the present disclosure. After performing the described post-processing technique on the video, the post-processing device generates composite frame 1500 from exemplary frame 1400 of FIG. 14. As shown, composite frame 1500 is generated using data composited frame multiple neighboring/adjacent frames (e.g., 7 frames; 3 iterations) rather than just one (in exemplary frame 1400). The present selective compositing technique not only removes/reduces (chromatic) noise in the composite frame 1500, but reduces blocky compression artifacts, reducing banding effects (in e.g., the sky 1502), and smooths any exposure changes between frames of video. Exposure smoothing between frames occurs because auto-exposure differences between frames may be smoothed over a plurality of frames (e.g., 7 frames/3 iterations).

The post-processing device may repeat the process where there are additional frames (step 220, yes branch), incrementing the current frame to the next frame. In some examples, the denoising process is performed again with the composited frames as the extracted frames. In further examples, during the repeated denoising process, only a single iteration is performed.

When there are no further frames to process (step 220, no branch), the post-processing device may generate a final composited video including the composited frames. In some examples, further post-processing is performed on the composited frames. The final composited video may be encoded into a video file by a codec of the post-processing device. In some examples, the FFMpeg tool is used to generate and encode the final composited video.

At step 224, the post-processing device may cleanup/delete intermediate files generated during the creation of the final composited video including the extracted frames, the scaled frames, the optical flow motion vectors, the synthetic frames, the composited frames, and/or files generated during a second denoising process.

### EXEMPLARY ARCHITECTURE

### System Architecture

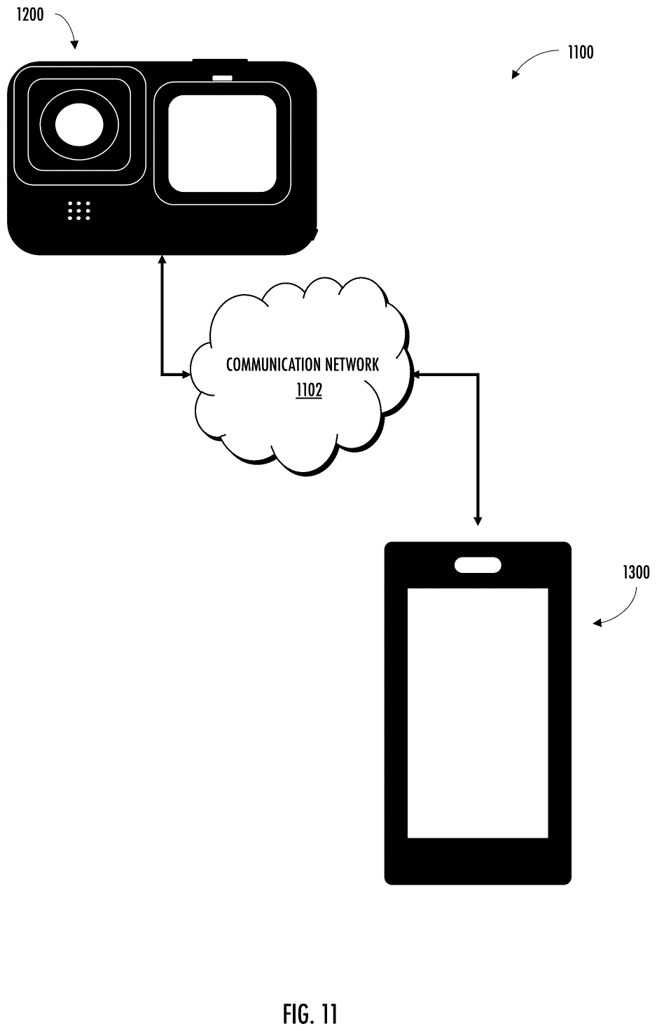

FIG. 11 is a logical block diagram of the exemplary system 1100 that includes: a capture device 1200, a post-processing device 1300, and a communication network 1102. The capture device 1200 may capture one or more videos or frames of videos and transfer the videos to the post-processing device 1300 directly or via communication network 1102 for post-processing to, e.g., reduce noise in captured video. The post-processed video may be shared with additional devices via communication network 1102.

The following discussion provides functional descriptions for each of the logical entities of the exemplary system 1100. Artisans of ordinary skill in the related art will readily appreciate that other logical entities that do the same work in substantially the same way to accomplish the same result are equivalent and may be freely interchanged. A specific discussion of the structural implementations, internal operations, design considerations, and/or alternatives, for each of the logical entities of the exemplary system 1100 is separately provided below.

### Functional Overview of the Capture Device

Functionally, a capture device 1200 captures and processes video. The captured video may include high-frame rate video for better application of other post processing effects such as electronic image stabilization and slow-motion techniques. In certain implementations, the capture device captures and processes the video to include post-capture motion blur. In other implementations, the capture device 1200 captures video that is transferred to a post-processing device for further processing, including to reduce noise in video.

The techniques described throughout may be broadly applicable to capture devices such as cameras including action cameras, digital cameras, digital video cameras; cellular phones; laptops; smart watches; and/or IoT devices. For example, a smart phone or laptop may be able to capture and process video. Various other applications may be substitute with equal success by artisans of ordinary skill, given the contents of the present disclosure.

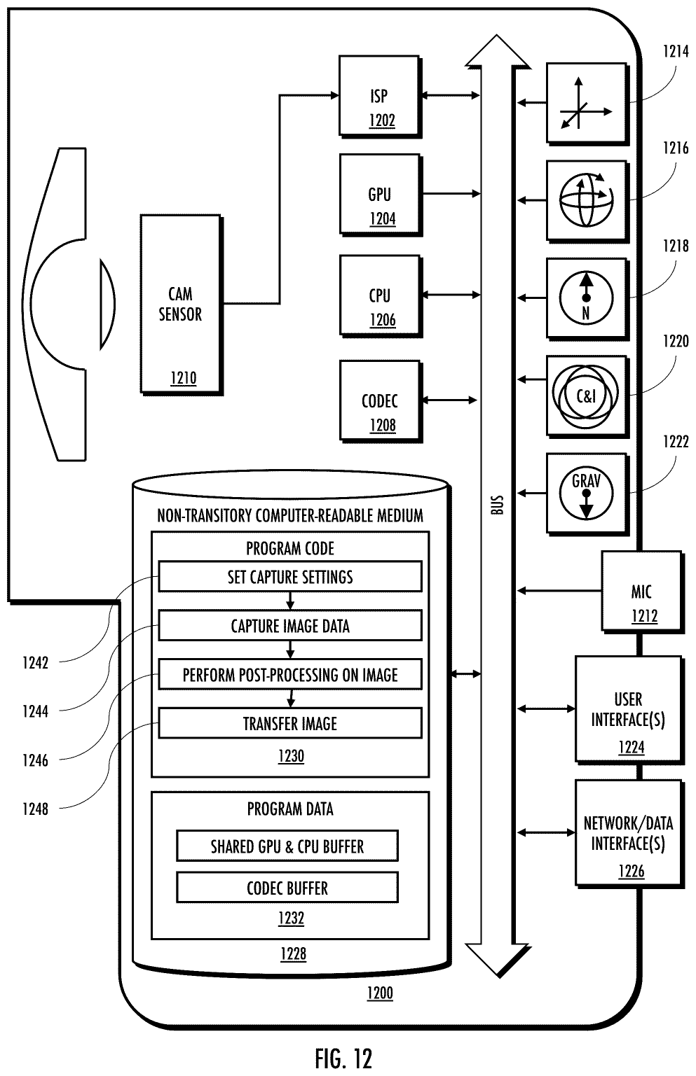

FIG. 12 is a logical block diagram of an exemplary capture device 1200. The capture device 1200 includes: a sensor subsystem, a user interface subsystem, a communication subsystem, a control and data subsystem, and a bus to enable data transfer. The following discussion provides a specific discussion of the internal operations, design considerations, and/or alternatives, for each subsystem of the exemplary capture device 1200.

### Functional Overview of the Sensor Subsystem

Functionally, the sensor subsystem senses the physical environment and captures and/or records the sensed environment as data. In some embodiments, the sensor data may be stored as a function of capture time (so-called “tracks”). Tracks may be synchronous (aligned) or asynchronous (non-aligned) to one another. In some embodiments, the sensor data may be compressed, encoded, and/or encrypted as a data structure (e.g., MPEG, WAV, etc.)

The illustrated sensor subsystem includes: a camera sensor 1210, a microphone 1212, an accelerometer (ACCL 1214), a gyroscope (GYRO 1216), and a magnetometer (MAGN 1218).

Other sensor subsystem implementations may multiply, combine, further sub-divide, augment, and/or subsume the foregoing functionalities within these or other subsystems. For example, two or more cameras may be used to capture panoramic (e.g., wide or) 360° or stereoscopic content. Similarly, two or more microphones may be used to record stereo sound.

In some embodiments, the sensor subsystem is an integral part of the capture device 1200. In other embodiments, the sensor subsystem may be augmented by external devices and/or removably attached components (e.g., hot-shoe/cold-shoe attachments, etc.) The following sections provide detailed descriptions of the individual components of the sensor subsystem.

### Camera Implementations and Design Considerations

In one exemplary embodiment, a camera lens bends (distorts) light to focus on the camera sensor 1210. In one specific implementation, the optical nature of the camera lens is mathematically described with a lens polynomial. More generally however, any characterization of the camera lens' optical properties may be substituted with equal success; such characterizations may include without limitation: polynomial, trigonometric, logarithmic, look-up-table, and/or piecewise or hybridized functions thereof. In one variant, the camera lens provides a wide field-of-view greater than 90°; examples of such lenses may include e.g., panoramic lenses 120° and/or hyper-hemispherical lenses 180°.

In one specific implementation, the camera sensor 1210 senses light (luminance) via photoelectric sensors (e.g., CMOS sensors). A color filter array (CFA) value provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image.

More generally however, the various techniques described herein may be broadly applied to any camera assembly; including e.g., narrow field-of-view (30° to) 90° and/or stitched variants (e.g., 360° panoramas). While the foregoing techniques are described in the context of perceptible light, the techniques may be applied to other EM radiation capture and focus apparatus including without limitation: infrared, ultraviolet, and/or X-ray, etc.

As a brief aside, “exposure” is based on three parameters: aperture, ISO (sensor gain) and shutter speed (exposure time). Exposure determines how light or dark an image will appear when it's been captured by the camera(s). During normal operation, a digital camera may automatically adjust one or more settings including aperture, ISO, and shutter speed to control the amount of light that is received. Most action cameras are fixed aperture cameras due to form factor limitations and their most common use cases (varied lighting conditions)-fixed aperture cameras only adjust ISO and shutter speed. Traditional digital photography allows a user to set fixed values and/or ranges to achieve desirable aesthetic effects (e.g., shot placement, blur, depth of field, noise, etc.).

The term “shutter speed” refers to the amount of time that light is captured. Historically, a mechanical “shutter” was used to expose film to light; the term shutter is still used, even in digital cameras that lack of such mechanisms. For example, some digital cameras use an electronic rolling shutter (ERS) that exposes rows of pixels to light at slightly different times during the image capture. Specifically, CMOS image sensors use two pointers to clear and write to each pixel value. An erase pointer discharges the photosensitive cell (or rows/columns/arrays of cells) of the sensor to erase it; a readout pointer then follows the erase pointer to read the contents of the photosensitive cell/pixel. The capture time is the time delay in between the erase and readout pointers. Each photosensitive cell/pixel accumulates the light for the same exposure time, but they are not erased/read at the same time since the pointers scan through the rows. A faster shutter speed has a shorter capture time, a slower shutter speed has a longer capture time.

A related term, “shutter angle” describes the shutter speed relative to the frame rate of a video. A shutter angle of 360° means all the motion from one video frame to the next is captured, e.g., video with 24 frames per second (FPS) using a 360° shutter angle will expose the photosensitive sensor for 1/24th of a second. Similarly, 120 FPS using a 360° shutter angle exposes the photosensitive sensor 1/120th of a second. In low light, the camera will typically expose longer, increasing the shutter angle, resulting in more motion blur. Larger shutter angles result in softer and more fluid motion, since the end of blur in one frame extends closer to the start of blur in the next frame. Smaller shutter angles appear stuttered and disjointed since the blur gap increases between the discrete frames of the video. In some cases, smaller shutter angles may be desirable for capturing crisp details in each frame. For example, the most common setting for cinema has been a shutter angle near 180°, which equates to a shutter speed near 1/48th of a second at 24 FPS. Some users may use other shutter angles that mimic old 1950's newsreels (shorter than) 180°.

In some embodiments, the camera resolution directly corresponds to light information. In other words, the Bayer sensor may match one pixel to a color and light intensity (each pixel corresponds to a photosite). However, in some embodiments, the camera resolution does not directly correspond to light information. Some high-resolution cameras use an N-Bayer sensor that groups four, or even nine, pixels per photosite. During image signal processing, color information is re-distributed across the pixels with a technique called “pixel binning”. Pixel-binning provides better results and versatility than just interpolation/upscaling. For example, a camera can capture high resolution images (e.g., 108 MPixels) in full-light; but in low-light conditions, the camera can emulate a much larger photosite with the same sensor (e.g., grouping pixels in sets of 9 to get a 12 MPixel “nona-binned” resolution). Unfortunately, cramming photosites together can result in “leaks” of light between adjacent pixels (i.e., sensor noise). In other words, smaller sensors and small photosites increase noise and decrease dynamic range.

### Microphone Implementations and Design Considerations

In one specific implementation, the microphone 1212 senses acoustic vibrations and converts the vibrations to an electrical signal (via a transducer, condenser, etc.) The electrical signal may be further transformed to frequency domain information. The electrical signal is provided to the audio codec, which samples the electrical signal and converts the time domain waveform to its frequency domain representation. Typically, additional filtering and noise reduction may be performed to compensate for microphone characteristics. The resulting audio waveform may be compressed for delivery via any number of audio data formats.

Commodity audio codecs generally fall into speech codecs and full spectrum codecs. Full spectrum codecs use the modified discrete cosine transform (mDCT) and/or mel-frequency cepstral coefficients (MFCC) to represent the full audible spectrum. Speech codecs reduce coding complexity by leveraging the characteristics of the human auditory/speech system to mimic voice communications. Speech codecs often make significant trade-offs to preserve intelligibility, pleasantness, and/or data transmission considerations (robustness, latency, bandwidth, etc.)

More generally however, the various techniques described herein may be broadly applied to any integrated or handheld microphone or set of microphones including, e.g., boom and/or shotgun-style microphones. While the foregoing techniques are described in the context of a single microphone, multiple microphones may be used to collect stereo sound and/or enable audio processing. For example, any number of individual microphones can be used to constructively and/or destructively combine acoustic waves (also referred to as beamforming).

### Inertial Measurement Unit (IMU) Implementations and Design Considerations

The inertial measurement unit (IMU) includes one or more accelerometers, gyroscopes, and/or magnetometers. In one specific implementation, the accelerometer (ACCL 1214) measures acceleration and gyroscope (GYRO 1216) measure rotation in one or more dimensions. These measurements may be mathematically converted into a four-dimensional (4D) quaternion to describe the device motion, and electronic image stabilization (EIS) may be used to offset image orientation to counteract device motion (e.g., CORI/IORI 1220). In one specific implementation, the magnetometer (MAGN 1218) may provide a magnetic north vector (which may be used to “north lock” video and/or augment location services such as GPS), similarly the accelerometer (ACCL 1214) may also be used to calculate a gravity vector (GRAV 1222).

Typically, an accelerometer uses a damped mass and spring assembly to measure proper acceleration (i.e., acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed to determine velocity (both device direction and speed).

More generally, however, any scheme for detecting device velocity (direction and speed) may be substituted with equal success for any of the foregoing tasks. While the foregoing techniques are described in the context of an inertial measurement unit (IMU) that provides quaternion vectors, artisans of ordinary skill in the related arts will readily appreciate that raw data (acceleration, rotation, magnetic field) and any of their derivatives may be substituted with equal success.

### Functional Overview of the User Interface Subsystem

Functionally, the user interface subsystem 1224 may be used to present media to, and/or receive input from, a human user. Media may include any form of audible, visual, and/or haptic content for consumption by a human. Examples include images, videos, sounds, and/or vibration. Input may include any data entered by a user either directly (via user entry) or indirectly (e.g., by reference to a profile or other source).

The illustrated user interface subsystem 1224 may include: a touchscreen, physical buttons, and a microphone. In some embodiments, input may be interpreted from touchscreen gestures, button presses, device motion, and/or commands (verbally spoken). The user interface subsystem may include physical components (e.g., buttons, keyboards, switches, scroll wheels, etc.) or virtualized components (via a touchscreen).

Other user interface subsystem 1224 implementations may multiply, combine, further sub-divide, augment, and/or subsume the foregoing functionalities within these or other subsystems. For example, the audio input may incorporate elements of the microphone (discussed above with respect to the sensor subsystem). Similarly, IMU based input may incorporate the aforementioned IMU to measure “shakes”, “bumps” and other gestures.

In some embodiments, the user interface subsystem 1224 is an integral part of the capture device 1200. In other embodiments, the user interface subsystem may be augmented by external devices (such as the post-processing device 1300, discussed below) and/or removably attached components (e.g., hot-shoe/cold-shoe attachments, etc.) The following sections provide detailed descriptions of the individual components of the sensor subsystem.

### Touchscreen and Buttons Implementation and Design Considerations

In some embodiments, the user interface subsystem 1224 may include a touchscreen panel. A touchscreen is an assembly of a touch-sensitive panel that has been overlaid on a visual display. Typical displays are liquid crystal displays (LCD), organic light emitting diodes (OLED), and/or active-matrix OLED (AMOLED). Touchscreens are commonly used to enable a user to interact with a dynamic display, this provides both flexibility and intuitive user interfaces. Within the context of action cameras, touchscreen displays are especially useful because they can be sealed (waterproof, dust-proof, shock-proof, etc.)

Most commodity touchscreen displays are either resistive or capacitive. Generally, these systems use changes in resistance and/or capacitance to sense the location of human finger(s) or other touch input. Other touchscreen technologies may include, e.g., surface acoustic wave, surface capacitance, projected capacitance, mutual capacitance, and/or self-capacitance. Yet other analogous technologies may include, e.g., projected screens with optical imaging and/or computer-vision.

In some embodiments, the user interface subsystem 1224 may also include mechanical buttons, keyboards, switches, scroll wheels and/or other mechanical input devices. Mechanical user interfaces are usually used to open or close a mechanical switch, resulting in a differentiable electrical signal. While physical buttons may be more difficult to seal against the elements, they are nonetheless useful in low-power applications since they do not require an active electrical current draw. For example, many BLE applications may be triggered by a physical button press to further reduce GUI power requirements.

More generally, however, any scheme for detecting user input may be substituted with equal success for any of the foregoing tasks. While the foregoing techniques are described in the context of a touchscreen and physical buttons that enable user data entry, artisans of ordinary skill in the related arts will readily appreciate that any of their derivatives may be substituted with equal success.

### Microphone/Speaker Implementation and Design Considerations

Audio input may incorporate a microphone and codec (discussed above) with a speaker. As previously noted, the microphone can capture and convert audio for voice commands. For audible feedback, the audio codec may obtain audio data and decode the data into an electrical signal. The electrical signal can be amplified and used to drive the speaker to generate acoustic waves.

As previously noted, the microphone and speaker may have any number of microphones and/or speakers for beamforming. For example, two speakers may be used to provide stereo sound. Multiple microphones may be used to collect both the user's vocal instructions as well as the environmental sounds.

### Functional Overview of the Communication Subsystem

Functionally, the communication subsystem may be used to transfer data to, and/or receive data from, external entities. The communication subsystem is generally split into network interfaces and removeable media (data) interfaces. The network interfaces are configured to communicate with other nodes of a communication network according to a communication protocol. Data may be received/transmitted as transitory signals (e.g., electrical signaling over a transmission medium.) The data interfaces are configured to read/write data to a removeable non-transitory computer-readable medium (e.g., flash drive or similar memory media).

The illustrated network/data interface 1226 may include network interfaces including, but not limited to: Wi-Fi, Bluetooth, Global Positioning System (GPS), USB, and/or Ethernet network interfaces. Additionally, the network/data interface 1226 may include data interfaces such as: SD cards (and their derivatives) and/or any other optical/electrical/magnetic media (e.g., MMC cards, CDs, DVDs, tape, etc.).

### Network Interface Implementation and Design Considerations

The communication subsystem including the network/data interface 1226 of the capture device 1200 may include one or more radios and/or modems. As used herein, the term “modem” refers to a modulator-demodulator for converting computer data (digital) into a waveform (baseband analog). The term “radio” refers to the front-end portion of the modem that upconverts and/or downconverts the baseband analog waveform to/from the RF carrier frequency.

As previously noted, communication subsystem with network/data interface 1226 may include wireless subsystems (e.g., 5^{th}/6^{th} Generation (5G/6G) cellular networks, Wi-Fi, Bluetooth (including, Bluetooth Low Energy (BLE) communication networks), etc.) Furthermore, the techniques described throughout may be applied with equal success to wired networking devices. Examples of wired communications include without limitation Ethernet, USB, PCI-e. Additionally, some applications may operate within mixed environments and/or tasks. In such situations, the multiple different connections may be provided via multiple different communication protocols. Still other network connectivity solutions may be substituted with equal success.

More generally, any scheme for transmitting data over transitory media may be substituted with equal success for any of the foregoing tasks.

### Data Interface Implementation and Design Considerations

The communication subsystem of the capture device 1200 may include one or more data interfaces for removeable media. In one exemplary embodiment, the capture device 1200 may read and write from a Secure Digital (SD) card or similar card memory.

While the foregoing discussion is presented in the context of SD cards, artisans of ordinary skill in the related arts will readily appreciate that other removeable media may be substituted with equal success (flash drives, MMC cards, etc.) Furthermore, the techniques described throughout may be applied with equal success to optical media (e.g., DVD, CD-ROM, etc.).

More generally, any scheme for storing data to non-transitory media may be substituted with equal success for any of the foregoing tasks.

### Functional Overview of the Control and Data Processing Subsystem

Functionally, the control and data processing subsystems are used to read/write and store data to effectuate calculations and/or actuation of the sensor subsystem, user interface subsystem, and/or communication subsystem. While the following discussions are presented in the context of processing units that execute instructions stored in a non-transitory computer-readable medium (memory), other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

As shown in FIG. 12, the control and data subsystem may include one or more of: a central processing unit (CPU 1206), an image signal processor (ISP 1202), a graphics processing unit (GPU 1204), a codec 1208, and a non-transitory computer-readable medium 1228 that stores program instructions and/or data.

### Processor-Memory Implementations and Design Considerations

As a practical matter, different processor architectures attempt to optimize their designs for their most likely usages. More specialized logic can often result in much higher performance (e.g., by avoiding unnecessary operations, memory accesses, and/or conditional branching). For example, a general-purpose CPU (such as shown in FIG. 12) may be primarily used to control device operation and/or perform tasks of arbitrary complexity/best-effort. CPU operations may include, without limitation: general-purpose operating system (OS) functionality (power management, UX), memory management, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks, and must account for branch disruption and/or arbitrary memory access.

In contrast, the image signal processor (ISP) performs many of the same tasks repeatedly over a well-defined data structure. Specifically, the ISP maps captured camera sensor data to a color space. ISP operations often include, without limitation: demosaicing, color correction, white balance, and/or autoexposure. Most of these actions may be done with scalar vector-matrix multiplication. Raw image data has a defined size and capture rate (for video) and the ISP operations are performed identically for each pixel; as a result, ISP designs are heavily pipelined (and seldom branch), may incorporate specialized vector-matrix logic, and often rely on reduced addressable space and other task-specific optimizations. ISP designs only need to keep up with the camera sensor output to stay within the real-time budget; thus, ISPs more often benefit from larger register/data structures and do not need parallelization. In many cases, the ISP may locally execute its own real-time operating system (RTOS) to schedule tasks of according to real-time constraints.

Much like the ISP, the GPU is primarily used to modify image data and may be heavily pipelined (seldom branches) and may incorporate specialized vector-matrix logic. Unlike the ISP however, the GPU often performs image processing acceleration for the CPU, thus the GPU may need to operate on multiple images at a time and/or other image processing tasks of arbitrary complexity. In many cases, GPU tasks may be parallelized and/or constrained by real-time budgets. GPU operations may include, without limitation: stabilization, lens corrections (stitching, warping, stretching), image corrections (shading, blending), noise reduction (filtering, etc.). GPUs may have much larger addressable space that can access both local cache memory and/or pages of system virtual memory. Additionally, a GPU may include multiple parallel cores and load balancing logic to e.g., manage power consumption and/or performance. In some cases, the GPU may locally execute its own operating system to schedule tasks according to its own scheduling constraints (pipelining, etc.).

The hardware codec converts image data to an encoded data for transfer and/or converts encoded data to image data for playback. Much like ISPs, hardware codecs are often designed according to specific use cases and heavily commoditized. Typical hardware codecs are heavily pipelined, may incorporate discrete cosine transform (DCT) logic (which is used by most compression standards), and often have large internal memories to hold multiple frames of video for motion estimation (spatial and/or temporal). As with ISPs, codecs are often bottlenecked by network connectivity and/or processor bandwidth, thus codecs are seldom parallelized and may have specialized data structures (e.g., registers that are a multiple of an image row width, etc.). In some cases, the codec may locally execute its own operating system to schedule tasks according to its own scheduling constraints (bandwidth, real-time frame rates, etc.).

Other processor subsystem implementations may multiply, combine, further sub-divide, augment, and/or subsume the foregoing functionalities within these or other processing elements. For example, multiple ISPs may be used to service multiple camera sensors. Similarly, codec functionality may be subsumed with either GPU or CPU operation via software emulation.

In one embodiment, the memory subsystem may be used to store data locally at the capture device 1200. In one exemplary embodiment, data may be stored as non-transitory symbols (e.g., bits read from non-transitory computer-readable mediums.) In one specific implementation, the memory subsystem including non-transitory computer-readable medium 1228 is physically realized as one or more physical memory chips (e.g., NAND/NOR flash) that are logically separated into memory data structures. The memory subsystem may be bifurcated into program code 1230 and/or program data 1232. In some variants, program code and/or program data may be further organized for dedicated and/or collaborative use. For example, the GPU and CPU may share a common memory buffer to facilitate large transfers of data therebetween. Similarly, the codec may have a dedicated memory buffer to avoid resource contention.

In some embodiments, the program code may be statically stored within the capture device 1200 as firmware. In other embodiments, the program code may be dynamically stored (and changeable) via software updates. In some such variants, software may be subsequently updated by external parties and/or the user, based on various access permissions and procedures.

### Generalized Operation of the Capture Device

In one embodiment, the non-transitory computer-readable medium includes a routine that enables the capture of video for reducing noise in post-processing. In some examples, the capture device may perform parts or all of the post-processing on the device. In other examples, the capture device may transfer the video to another device for additional processing. When executed by the control and data subsystem, the routine causes the capture device to: set capture settings, capture image data, perform post-processing on the image data, and transfer the image data to a post-processing device. These steps are discussed in greater detail below.

At step 1242, the capture device may set capture settings. Capture settings may be retrieved via user input at the user interface subsystem 1224. Settings may also be determined via sensor data using the sensor subsystem to determine exposure settings, a camera mode may alter or constrain capture settings (e.g., an automatic mode, priority modes, a slow-motion capture mode, etc.). In some variants, capture settings may be based on intended post-processing effects.

At step 1244, the capture device may capture video using the camera sensor 1210 with the capture settings. The capture device may perform processing of the captured images using the control and data subsystem including the ISP 1202. The video may be encoded using codec 1208.

In some implementations, depth may be explicitly determined based on a depth sensor or derived from a stereo camera setup. As previously noted, depth information may improve downstream post-processing. For example, depth maps can be used to discern between objects that pass in front of and behind other objects in a scene (occlusions). Accordingly, depth information may be used in conjunction with other techniques (e.g., optical flow) to generate more accurate motion information. This may allow for more accurate synthetic frame generation (in, e.g., post processing) useful to reduce noise in video.

At step 1246, the capture device may perform post-processing on video. Post-processing may include image/video stabilization, adding slow motion effects, scaling a video playback, and performing noise reduction (as discussed herein).

At step 1248, the capture device may transfer video. The captured video may be stored on internal or removable storage and transferred using wired or wireless mechanisms (via the network/data interface 1226) or via transferring the removable storage to another device (e.g., the post-processing device 1300).

While the foregoing actions are presented in the context of a capture device that capture video for adding post-processing motion blur, those of ordinary skill in the related arts will readily appreciate that the actions may be broadly extended to many different use cases (including, e.g., for performing other post-processing activities and sharing/viewing captured media).

### Functional Overview of the Post-Processing Device

Functionally, a post-processing device 1300 refers to a device that can receive and process image/video data. The post-processing device 1300 has many similarities in operation and implementation to the capture device 1200 which are not further discussed; the following discussion provides a discussion of the internal operations, design considerations, and/or alternatives, that are specific to post-processing device 1300 operation. Additionally, certain actions performed by the post-processing device 1300 may be performed by the capture device 1200.

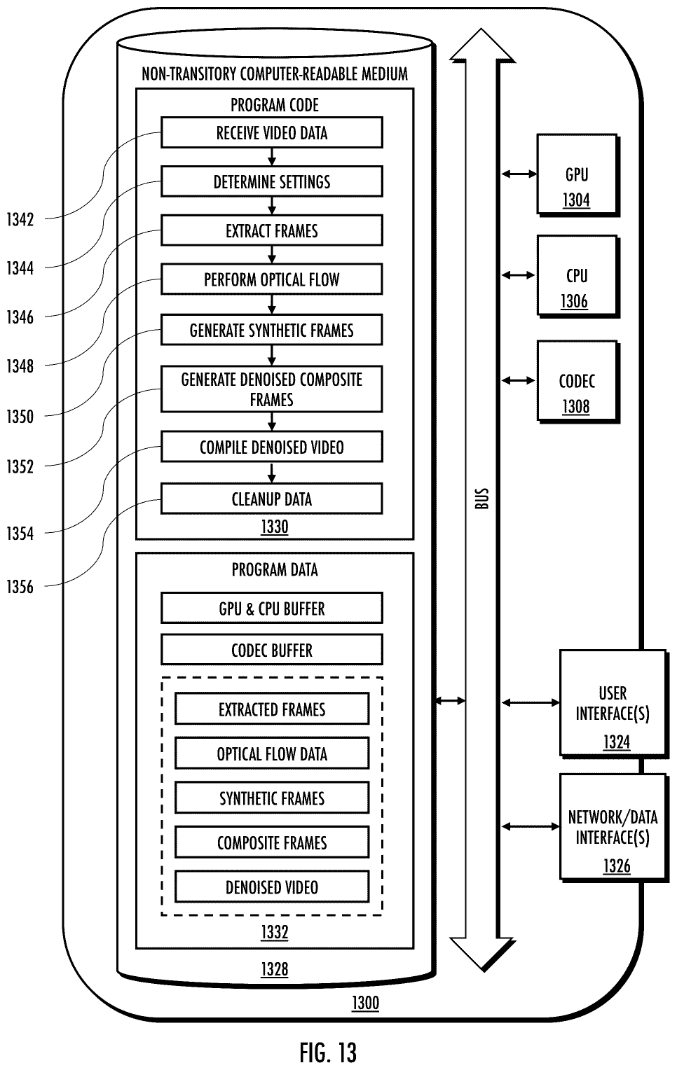

FIG. 13 is a logical block diagram of an exemplary post-processing device 1300. The post-processing device 1300 includes: a user interface subsystem, a communication subsystem, a control and data subsystem, and a bus to enable data transfer. The following discussion provides a specific discussion of the internal operations, design considerations, and/or alternatives, for each subsystem of the exemplary post-processing device 1300.

### Functional Overview of the User Interface Subsystem

Functionally, the user interface subsystem 1324 may be used to present media to, and/or receive input from, a human user. Media may include any form of audible, visual, and/or haptic content for consumption by a human. Examples include images, videos, sounds, and/or vibration. Input may include any data entered by a user either directly (via user entry) or indirectly (e.g., by reference to a profile or other source).

The illustrated user interface subsystem 1324 may include: a touchscreen, physical buttons, and a microphone. In some embodiments, input may be interpreted from touchscreen gestures, button presses, device motion, and/or commands (verbally spoken). The user interface subsystem may include physical components (e.g., buttons, keyboards, switches, scroll wheels, etc.) or virtualized components (via a touchscreen).

### User Interface Subsystem Considerations for Different Device Types

The illustrated user interface subsystem 1324 may include user interfaces that are typical of the specific device types which include, but are not limited to: a desktop computer, a network server, a smart phone, and a variety of other devices are commonly used in the mobile device ecosystem including without limitation: laptops, tablets, smart phones, smart watches, smart glasses, and/or other electronic devices. These different device-types often come with different user interfaces and/or capabilities.

In laptop embodiments, user interface devices may include both keyboards, mice, touchscreens, microphones and/speakers. Laptop screens are typically quite large, providing display sizes well more than 2K (2560×1440), 4K (3840×2160), and potentially even higher. In many cases, laptop devices are less concerned with outdoor usage (e.g., water resistance, dust resistance, shock resistance) and often use mechanical button presses to compose text and/or mice to maneuver an on-screen pointer.

In terms of overall size, tablets are like laptops and may have display sizes well more than 2K (2560×1440), 4K (3840×2160), and potentially even higher. Tablets tend to eschew traditional keyboards and rely instead on touchscreen and/or stylus inputs.

Smart phones are smaller than tablets and may have display sizes that are significantly smaller, and non-standard. Common display sizes include e.g., 2400×1080, 2556×1179, 2796×1290, etc. Smart phones are highly reliant on touchscreens but may also incorporate voice inputs. Virtualized keyboards are quite small and may be used with assistive programs (to prevent mis-entry).

Smart watches and smart glasses have not had widespread market adoption but will likely become more popular over time. Their user interfaces are currently quite diverse and highly subject to implementation.

### Functional Overview of the Communication Subsystem

Functionally, the communication subsystem may be used to transfer data to, and/or receive data from, external entities. The communication subsystem is generally split into network interfaces and removeable media (data) interfaces. The network interfaces are configured to communicate with other nodes of a communication network according to a communication protocol. Data may be received/transmitted as transitory signals (e.g., electrical signaling over a transmission medium.) In contrast, the data interfaces are configured to read/write data to a removeable non-transitory computer-readable medium (e.g., flash drive or similar memory media).

The illustrated network/data interface 1326 of the communication subsystem may include network interfaces including, but not limited to: Wi-Fi, Bluetooth, Global Positioning System (GPS), USB, and/or Ethernet network interfaces. Additionally, the network/data interface 1326 may include data interfaces such as: SD cards (and their derivatives) and/or any other optical/electrical/magnetic media (e.g., MMC cards, CDs, DVDs, tape, etc.)

### Functional Overview of the Control and Data Processing Subsystem

Functionally, the control and data processing subsystems are used to read/write and store data to effectuate calculations and/or actuation of the user interface subsystem, and/or communication subsystem. While the following discussions are presented in the context of processing units that execute instructions stored in a non-transitory computer-readable medium (memory), other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

As shown in FIG. 13, the control and data subsystem may include one or more of: a central processing unit (CPU 1306), a graphics processing unit (GPU 1304), a codec 1308, and a non-transitory computer-readable medium 1328 that stores program instructions (program code 1330) and/or program data 1332 (including a GPU buffer, a CPU buffer, and a codec buffer). In some examples, buffers may be shared between processing components to facilitate data transfer.

### Generalized Operation of the Post-Processing Device

In one embodiment, the non-transitory computer-readable medium 1328 includes program code 1330 with instructions/a routine that performs post-processing, including reducing noise in video. When executed by the control and data subsystem, the routine causes the post-processing device to: receive user input for noise reduction settings, receive video data, extract frames from the video data, determine optical flow on the frames, generating motion vectors, generating synthetic frames, analyzing current and synthetic frames to generate masks, masking the synthetic frames, compositing the current frame and synthetic frames, compiling and encoding the denoised video, performing cleanup operations, and sending the denoised video for sharing and display. In generating the denoised video, other program data 1332 may be generated including extracted frames, optical flow data, synthetic frames, and composite frames.

An overview of the video denoising process is described with reference to the following pseudocode segments useful to illustrate the described concepts. While the pseudocode is described in Python and uses particular utilities and libraries, persons of ordinary skill will understand given the contents of the present disclosure that other programming languages, utilities, and libraries may be used with equal success. Pseudocode Segment 1, with further detail below. Pseudocode Segment 1 includes a function run_averaging( ) that performs a denoising process on input video.

Pseudocode Segment 1

| | |
|---|---|
| 01. | def run_averaging( ): |
| 02. | input_video = input_video_var.get( ) |
| 03. | if not input_video: |
| 04. | messagebox.showerror(“Error”, “Please select a valid input |

video file.”)

| | |
|---|---|
| 05. | return |
| 06. | |
| 07. | # Extract frames from the input video |
| 08. | extract_frames(input_video) |
| 09. | |
| 10. | # Compute optical flow |
| 11. | compute_optical_flow( ) |
| 12. | |
| 13. | iterations = iterations_slider.get( ) |
| 14. | |
| 15. | # Copy files from ‘input_large’ to ‘output’ for warping |
| 16. | copy_files(‘input_large’, ‘output’) |
| 17. | |
| 18. | # Run the warping script with iterations |
| 19. | run_warping(iterations) |
| 20. | |
| 21. | input_folder = ‘output’ # Use the ‘output’ folder as input for |

denoising

| | |
|---|---|
| 22. | output_folder = ‘output2’ if double_denoise_var.get( ) == 0 else |

‘output3’

| | |
|---|---|
| 23. | |
| 24. | # Perform selective averaging denoising |
| 25. | selective_average_frames(input_folder, output_folder, iterations, |

```
  threshold_slider1.get( ), threshold_slider2.get( ),
  threshold_slider3.get( ), threshold_slider4.get( ))
```

| | |
|---|---|
| 26. | |
| 27. | # Double denoise step if selected |
| 28. | if double_denoise_var.get( ) == 1: |
| 29. | double_denoise_output_folder = ‘output3’ |
| 30. | if not os.path.exists(double_denoise_output_folder): |
| 31. | os.makedirs(double_denoise_output_folder) |
| 32. | selective_average_frames(‘output2’, |

```
  double_denoise_output_folder, 1, double_threshold_slider.get( ),
  double_threshold_slider.get( ), double_threshold_slider.get( ),
  double_threshold_slider.get( ))
```

| | |
|---|---|
| 33. | |
| 34. | # After processing, compile images from ‘output3’ into the |

specified MP4 file

| | |
|---|---|
| 35. | output_video_path = output_file_var.get( ) # Use the variable |

associated with the Entry widget for output file path

| | |
|---|---|
| 36. | if not output_video_path.endswith(‘.mp4’): |
| 37. | messagebox.showerror(“Error”, “Output file must be an MP4 |

file.”)

| | |
|---|---|
| 38. | return |
| 39. | compile_to_video(output_folder, output_video_path) |
| 40. | |
| 41. | # Open the output video in the user's default media player |
| 42. | if os.path.isfile(output_video_path): |
| 43. | os.startfile(output_video_path) |
| 44 | else: |
| 45. | print(“Error: Output video not found.”) |

At step 1342, the post-processing device 1300 may receive video (see e.g., lines 2-5 of Pseudocode segment 1). In some examples, the video may be obtained via a removable storage media/a removable memory card or any network/data interface 1326. For instance, video from a capture device (e.g., capture device 1200) may be gathered by e.g., an internet server, a smartphone, a home computer, etc. and then transferred to the post-processing device 1300 via either wired or wireless transfer via network interfaces 1326. The video may then be transferred to the non-transitory computer-readable medium 1328 for temporary storage during processing or for long term storage.

At step 1344, the post-processing device 1300 may determine denoising settings. In some examples, the post-processing device 1300 generates a user interface and requests setting information from a user via the user interface subsystem 1324. The post-processing device 1300 may receive the settings information from the user via the user interface subsystem 1324. Pseudocode segment 2 shows an exemplary interface and request for settings.

Pseudocode Segment 2

| | |
|---|---|
| 46. | input_video_var = tk.StringVar( ) |
| 47. | output_file_var = tk.StringVar( ) |
| 48 | double_denoise_var = IntVar( ) |
| 49. | |
| 50. | tk.Label(root, text=“Input Video:”).grid(row=0, column=0) |
| 51. | input_entry = tk.Entry(root, textvariable=input_video_var, width=50) |
| 52. | input_entry.grid(row=0, column=1) |
| 53. | tk.Button(root, text=“Browse”, command=lambda: |

```
  input_video_var.set(filedialog.askopenfilename(filetypes=[(“Video files”,
  “*.mp4;*.mov;*.avi”)]))).grid(row=0, column=2)
```

| | |
|---|---|
| 54. | |
| 55. | # Request a file path |
| 56. | tk.Label(root, text=“Output Video:”).grid(row=1, column=0) |
| 57. | output_entry = tk.Entry(root, textvariable=output_file_var, width=50) |
| 58 | output_entry.grid(row=1, column=1) |
| 59. | tk.Button(root, text=“Browse”, command=lambda: |

```
  output_file_var.set(filedialog.asksaveasfilename(defaultextension=“.mp4”,
  filetypes=[(“MP4 files”, “*.mp4”)]))).grid(row=1, column=2)
```

| | |
|---|---|
| 60. | |
| 61. | # Iterations and threshold sliders |
| 62. | iterations_slider = Scale(root, from_=1, to=10, orient=‘horizontal’, |

label=‘Iterations', length=400)

| | |
|---|---|
| 63. | iterations_slider.set(1) |
| 64. | iterations_slider.grid(row=2, column=1) |
| 65. | |
| 66. | threshold_slider1 = Scale(root, from_=0, to=100, orient=‘horizontal’, |

label=‘Threshold 1 (%)’, length=400)

| | |
|---|---|
| 67. | threshold_slider1.set(6) |
| 68. | threshold_slider1.grid(row=3, column=1) |
| 69. | |
| 70 | threshold_slider2 = Scale(root, from_=0, to=100, orient=‘horizontal’, |

label=‘Threshold 2 (%)’, length=400)

| | |
|---|---|
| 71 | threshold_slider2.set(4) |
| 72. | threshold_slider2.grid(row=4, column=1) |
| 73. | |
| 74. | threshold_slider3 = Scale(root, from_=0, to=100, orient=‘horizontal’, |

label=‘Threshold 3 (%)’, length=400)

| | |
|---|---|
| 75. | threshold_slider3.set(3) |
| 76. | threshold_slider3.grid(row=5, column=1) |
| 77. | |
| 78. | threshold_slider4 = Scale(root, from_=0, to=100, orient=‘horizontal’, |

label=‘Threshold 4 (%)’, length=400)

| | |
|---|---|
| 79. | threshold_slider4.set(1) |
| 80. | threshold_slider4.grid(row=6, column=1) |
| 81 | |
| 82. | # Double denoise option |
| 83. | double_denoise_checkbutton = Checkbutton(root, text=“Double Denoise”, |

variable=double_denoise_var)

| | |
|---|---|
| 84. | double_denoise_checkbutton.grid(row=7, column=1) |
| 85. | |
| 86. | double_threshold_slider = Scale(root, from_=0, to=100, |

orient=‘horizontal’, label=‘Double_Threshold (%)’, length=400)

| | |
|---|---|
| 87. | double_threshold_slider.set(2) |
| 88. | double_threshold_slider.grid(row=8, column=1) |
| 89. | |
| 90. | # Buttons for running the process and cleanup |
| 91. | tk.Button(root, text=“Denoise!”, command=run_averaging, |

bg=“yellow”).grid(row=9, column=1)

| | |
|---|---|
| 92. | tk.Button(root, text=“Cleanup”, command=cleanup_folders, |

bg=“cyan”).grid(row=10, column=1)

Settings may include the location of the video file, an output location to store the denoised video, the number of iterations (e.g., levels of synthesizing and compositing) to perform (via a slider bars), difference masking thresholds (via slider bars), whether to perform a double-denoising (via a checkbox), double-denoising masking threshold(s) (via one or more sliders). Input buttons are also displayed to initiate the denoising process and to perform a cleanup operation.

At step 1346, the control and data subsystem of the post-processing device 1300 may extract frames from the received video.

Pseudocode Segment 3

| | |
|---|---|
| 93. | def extract_frames(input_video): |
| 94. | # Ensure the directories exist |
| 95. | if not os.path.exists(‘input_large’): |
| 96. | os.makedirs(‘input_large’) |
| 97. | if not os.path.exists(‘input’): |
| 98. | os.makedirs(‘input’) |
| 99. | |
| 100. | # High-quality frames extraction |
| 101. | command_large = f“ffmpeg -i \“{input_video}\” -qscale:v 2 |

output/frame%04d.jpg”

| | |
|---|---|
| 102. | subprocess.run(command_large, shell=True, check=True) |
| 103. | |
| 104. | # Scaled frames extraction |
| 105. | command_scaled = f“ffmpeg -i \“{input video}\” -vf |

\“scale=512:288\” -qscale:v 2 input/frame%04d.jpg”

| | |
|---|---|
| 106. | subprocess.run(command_scaled, shell=True, check=True) |

As shown in Pseudocode Segment 3, FFMPEG is called to perform the extraction of the frames (including decoding the video). The extraction may be performed twice. One time to extract a full-resolution version of the frames and a second time to generate a scaled (reduced size) version of the frames for use in calculating optical flow.

At step 1348, the control and data subsystem of the post-processing device 1300 may determine optical flow on the extracted frames. Scaled versions of the frames may be used to reduce processing complexity and time, however, optical flow analysis may be performed on the full-resolution frames. The control and data subsystem may determine the optical flow by calculating the movement of pixels, blocks, or identified objects in a series of frames in the video.

In some implementations, optical flow may be calculated in the forward direction. In other implementations, optical flow and/or motion vectors are calculated instead or additionally in the reverse direction. Differences in motion vectors between the forward and reverse directions may be based on the optical flow calculation, object detection, movement between frames, pixel selection, and/or other motion estimation. In some implementations, a depth map may be indirectly inferred from the characteristics of the optical flow.

The post-processing device 1300 may generate motion vectors that denote motion between frames of the video. The determined optical flow may be used to generate the motion vectors via the control and data subsystem. The motion vectors may explain how a pixel/block/feature from a first frame moves to its new position in the second frame. Motion vectors may contain a magnitude value and a direction (e.g., an angle) or values for movement in the X-direction and Y-direction between subsequent frames and may be manipulated by the control and data subsystem.

In some examples, motion vectors may also be generated in the reverse direction to estimate “reverse” motion. Notably, the forward and reverse motion may be the same magnitude with the opposite direction for simple linear interpolation, however polynomial, non-linear, and/or artificial intelligence-based interpolation schemes may have significant differences in magnitude and/or direction.

Other techniques can also be used to estimate the motion of objects between frames. For example, neural network processing/artificial intelligence to address non-linear motion for frame interpolation. Such processing may be performed by the CPU 1306 or using dedicated Neural Network Processing Unit (NPU) of the control and data subsystem for dedicated AI processing.

Optical flow may be generated using GMFlow, an AI-based Optical Flow tool, or other code to generate pixel movement/motion vector data. The optical flow may generate a number of output files containing motion vector information describing the motion of pixels between frames. The optical flow output files may be in a Middlebury flow files format or another format suitable for storing the optical flow output. The output “.flo” files may be saved in a flow_files directory.

At step 1350, the control and data subsystem of the post-processing device 1300 may generate synthetic frames. Synthetic frames may be generated by warping the extracted frames according to the motion vectors calculated during the optical flow analysis.

For each iteration, the post-processing device 1300 generates synthetic frames corresponding to neighboring frames temporally before and temporally after the current frame. For example, if the current frame is frame Fx, the first iteration includes Frame_{X-1} and Frame_{X+1}; the second iteration includes Frame_{X-2} and Frame_{X+2}; etc. Synthetic frames are then created by moving the pixels from their positions in the original frame to their positions in the current frame using the motion vector data. In this example, for a first iteration, motion vectors are applied to Frame_{X-1} to create a synthetic version of Frame_{X}, Frame_{X,FX-1}. For frames in iterations greater than 1, motion vectors may be applied in multiple steps. For example, motion vectors may be applied to Frame_{X-2} to create a synthetic version of Frame_{X-1}, Frame_{X-1,FX-2}, in the first step. Then other motion vectors are applied to the synthetic Frame_{X-1,FX-2} to create a synthetic Frame_{X,FX-2}.

Pseudocode Segment 4

| | |
|---|---|
| 107. | def copy_files(src_dir, dst_dir): |
| 108. | if not os.path.exists(dst_dir): |
| 109. | os.makedirs(dst_dir) |
| 110. | for item in os.listdir(src_dir): |
| 111. | s = os.path.join(src_dir, item) |
| 112. | d = os.path.join(dst_dir, item) |
| 113. | if os.path.isdir(s): |
| 114. | shutil.copytree(s, d, False, None) |
| 115. | else: |
| 116. | shutil.copy2(s, d) |
| 117. | |
| 118. | def run_warping(iterations): |
| 119. | warp_command = f“python Warp.py output |
| | flow_files output -- |

iterations {iterations}”

| | |
|---|---|
| 120. | subprocess.run(warp_command, shell=True, check=True) |

Pseudocode Segment 4 shows a function copy_files( ) to prepare a copy of the frames for manipulation (called in lines 15-16 of Pseudocode Segment 1). The run_warping( ) function passes the iterations setting information to a warping subprocess (at lines 119-120. The arguments include: “image_dir” defining a path to/location of the directory containing input images; “flow_dir”, defining a path to the directory containing input.flo files; “base_output_dir” defining the location of the base directory to save output images; “warp_strength” defining the strength of the warp effect (positive for forward, negative for reverse) with a default of 1.0; “flow_blur_radius” defining a radius for Gaussian blur applied to optical flow vectors with a default of 0; “iterations” defining the number of iterations to apply warp, with a default of 1; “num_threads” defining a number of threads for parallel processing with a default of 8.

Depending on the motion estimation technique, synthetic frames may be generated from motion information in extracted frames. Pseudocode Segment 5 describes the read_flo_file( ) blur_flow_vectors( ) resize_flow( ) warp_image( ) process_single_image( ) and process_images( ) functions used to generate the synthetic frames using the warping subprocess.

Pseudocode Segment 5

| | |
|---|---|
| 121. | def read_flo_file(flow_path): |
| 122. | flow = fz.read_flow(flow_path) |
| 123. | return flow |
| 124. | |
| 125. | def blur_flow_vectors(flow, flow_blur_radius): |
| 126. | if flow_blur_radius > 0: |
| 127. | ksize = 2 * flow_blur_radius + 1 |
| 128. | blurred_flow = cv2.blur(flow, (ksize, ksize)) |
| 129. | else: |
| 130. | blurred_flow = flow.copy( ) |
| 131. | return blurred_flow |
| 132. | |
| 133. | def resize_flow(flow, target_width, target_height): |
| 134. | original_height, original_width = flow.shape[:2] |
| 135. | scale_x = target_width / original_width |
| 136. | scale_y = target_height / original_height |
| 137. | resized_flow = cv2.resize(flow, (target_width, target_height), |

interpolation=cv2.INTER_LINEAR)

| | |
|---|---|
| 138. | resized_flow[:, :, 0] *= scale_x |
| 139. | resized_flow[:, :, 1] *= scale_y |
| 140. | return resized_flow |
| 141. | |
| 142. | def warp_image(image, flow, warp_strength=1.0): |
| 143. | h, w = image.shape[:2] |
| 144. | flow = cv2.resize( |
| 145. | w, (w, h)) |
| 146. | flow[:, :, 0] *= warp_strength |
| 147. | flow[:, :, 1] *= warp_strength |
| 148. | |
| 149. | # Create meshgrid for warping |
| 150. | x, y = np.meshgrid(np.arange(w), np.arange(h)) |
| 151. | x_new = (x + flow[:, :, 0]).astype(np.float32) |
| 152. | y_new = (y + flow[:, :, 1]).astype(np.float32) |
| 153. | |
| 154. | # Warp the image using the flow vectors with border replication |
| 155. | warped_image = cv2.remap(image, x_new, y_new, cv2.INTER_LINEAR, |

borderMode=cv2.BORDER_REPLICATE)

| | |
|---|---|
| 156. | return warped_image |
| 157. | |
| 158. | def process_single_image(image_path, flow_path, output_path, |

warp_strength, flow_blur_radius, width, height):

| | |
|---|---|
| 159. | image = Image.open(image_path).convert(“RGB”) |
| 160. | flow = read_flo_file(flow_path) |
| 161. | |
| 162. | flow = resize_flow(flow, width, height) |
| 163. | flow = blur_flow_vectors(flow, flow_blur_radius) |
| 164. | |
| 165. | image_np = np.array(image).astype(np.uint8) |
| 166. | warped_image_np = warp_image(image_np, flow, |

warp_strength=warp_strength)

| | |
|---|---|
| 167. | warped_image = Image.fromarray(warped_image_np) |
| 168. | warped_image.save(output_path, quality=90) |
| 169. | |
| 170. | def process_images(base_image_dir, flow_dir, base_output_dir, |

warp_strength, flow_blur_radius, num_iterations, num_threads=8):

| | |
|---|---|
| 171. | for iteration in range(1, num_iterations + 1): |
| 172. | for warp_dir in [1, −1]: |
| 173. | current_warp_strength = warp_strength * warp_dir |
| 174. | current_output_dir = os.path.join(base_output_dir, |

f“{current_warp_strength * iteration}”)

| | |
|---|---|
| 175. | current_input_dir = os.path.join(base_output_dir, |

```
  f“{current_warp_strength * (iteration − 1)}”) if iteration > 1 else
  base_image_dir
```

| | |
|---|---|
| 176. | |
| 177. | if not os.path.exists(current_output_dir): |
| 178. | os.makedirs(current_output_dir) |
| 179. | |
| 180. | image_files = |

sorted(glob.glob(os.path.join(current_input_dir, “*.jpg”)))

| | |
|---|---|
| 181. | flow_files = sorted(glob.glob(os.path.join(flow_dir, |

“*.flo”)))

| | |
|---|---|
| 182. | |
| 183. | if warp_dir == 1 and iteration > 1: # Forward warp with |

adjusted flow files for iterations beyond the first

| | |
|---|---|
| 184. | offset = iteration − 1 |
| 185. | flow_files = flow_files[offset:] + flow_files[:offset] |
| 186. | elif warp_dir == −1: # Backward warp with repeated flow |

files

| | |
|---|---|
| 187. | repeated_flow_files = [ ] |
| 188. | for i in range(len(flow_files)): |
| 189. | repeat_times = iteration if i == 0 else 1 |
| 190. | repeated_flow_files.extend([flow_files[i]] * |

repeat_times)

| | |
|---|---|
| 191. | flow_files = repeated_flow_files if iteration > 1 else |

flow_files

| | |
|---|---|
| 192. | |
| 193. | with ThreadPoolExecutor(max_workers=num_threads) as |

executor:

| | |
|---|---|
| 194. | futures = [ ] |
| 195. | for image_file, flow_file in zip(image_files, |

flow_files):

| | |
|---|---|
| 196. | output_path = os.path.join(current_output_dir, |

os.path.basename(image_file))

| | |
|---|---|
| 197. | image = Image.open(image_file).convert(“RGB”) |
| 198. | width, height = image.size |
| 199. | future = executor.submit(process_single_image, |

```
  image_file, flow_file, output_path, current_warp_strength,
  flow_blur_radius, width, height)
```

| | |
|---|---|
| 200. | futures.append(future) |
| 201. | |
| 202. | for future in as_completed(futures): |
| 203. | future.result( ) # This will raise any exceptions |

encountered

| | |
|---|---|
| 204. | |
| 205. | # Update the base image directory for the next iteration |
| 206. | if warp_dir == −1 and iteration < num_iterations: |
| 207. | base_image_dir = current_output_dir |

In the process_images( ) function (lines 170-207 of Pseudocode Segment 5), the post-processing device 1300 loops through each iteration (at line 172 of Pseudocode Segment 5) in both temporal directions (at line 173 of Pseudocode Segment 5). Directories are created for each iteration (both positive and negative) and populated with the total number of frames. In total, the post-processing device 1300 may generate 2×(the number of iterations)×(the number of frames) synthetic frames and create 2×(the number of iterations) directories to store and organize the synthetic frames. In some examples, synthetic frames may be generated in parallel. For example, as shown in lines 193-203 of Pseudocode Segment 5, image processing tasks may be split between multiple threads.

The process_single_image( ) function (lines 158-168 of Pseudocode Segment 5) may generate a single synthetic frame. A previous image, either an extracted frame or a previously generated synthetic frame, may be warped according to the optical flow calculation to generate a new synthetic frame. The warp_image( ) function (lines 142-156 of Pseudocode Segment 5) may read the optical flow data, e.g., via the read_flo_file( ) function (lines 121-123 of Pseudocode Segment 5). In some examples, a library (e.g., the Flowiz utility) may be used to open the optical flow file(s) and perform operations on the optical flow data. The warp_image( ) function may resize/re-scale the optical flow data to fit the frame size. This rescaling may be performed by the resize_flow( ) function (lines 133-140 of Pseudocode Segment 5). The optical flow data may be blurred, e.g., via the blur_flow_vectors( ) function (lines 125-131 of Pseudocode Segment 5). This may smooth motion and reduce artifacts in generated synthetic frames. The resulting optical flow data may be applied to the image data (of the frame or synthetic frame) generating the synthetic frame.

At step 1352, the control and data subsystem of the post-processing device 1300 may generate a set of denoised composite frames. The post-processing device 1300 may use a selective average denoising process to generate the denoised composite frames (see, e.g., line 25 of Pseudocode Segment 1). Pseduocode Segment 6 illustrates an exemplary function selective_average_frames( ) for masking synthetic frames and compositing the masked synthetic frames with the extracted frame.

Pseudocode Segment 6

| | |
|---|---|
| 208. | def selective_average_frames(input_folder, output_folder, iterations, |

threshold1, threshold2, threshold3, threshold4):

| | |
|---|---|
| 209. | present_frame_files = sorted(glob.glob(f‘{input_folder}/*.png’)) + |

sorted(glob.glob(f‘{input_folder}/*.jpg’))

| | |
|---|---|
| 210 | num_present_frames = len(present_frame_files) |
| 211. | |
| 212. | subfolders = [f.path for f in os.scandir(input_folder) if |

f.is_dir( )]

| | |
|---|---|
| 213. | use_subfolders = len(subfolders) > 0 |
| 214. | |
| 215. | for i, present_filename in enumerate(present_frame_files): |
| 216. | current_frame = cv.imread(present_filename) |
| 217. | avg_frame = np.zeros_like(current_frame, dtype=float) |
| 218. | inclusion_count = np.ones_like(current_frame[:, :, 0], |

dtype=float)

| | |
|---|---|
| 219. | |
| 220. | if use_subfolders: |
| 221. | for j in range(1, iterations + 1): |
| 222. | threshold_percentage = threshold1 if j == 1 else |

threshold2 if j == 2 else threshold3 if j == 3 else threshold4

| | |
|---|---|
| 223. | |
| 224. | for sign in [1, −1]: |
| 225. | subfolder_name = f“{sign * j}.0” |
| 226. | subfolder_path = os.path.join(input_folder, |

subfolder_name)

| | |
|---|---|
| 227. | frame_idx = i + sign * j |
| 228. | |
| 229. | if os.path.exists(subfolder_path) and 0 <= |

frame_idx < num_present_frames:

| | |
|---|---|
| 230. | comparison_frame_path = |

```
  os.path.join(subfolder_path,
  os.path.basename(present_frame_files[frame_idx]))
```

| | |
|---|---|
| 231. | if os.path.exists(comparison_frame_path): |
| 232. | comparison_frame = |

cv.imread(comparison_frame_path)

| | |
|---|---|
| 233. | diff = cv.absdiff(current_frame, |

comparison_frame)

| | |
|---|---|
| 234. | diff_gray = cv.cvtColor(diff, |

cv.COLOR_BGR2GRAY)

| | |
|---|---|
| 235. | _, mask = cv.threshold(diff_gray, |

threshold_percentage * 2.55, 1, cv.THRESH_BINARY_INV)

| | |
|---|---|
| 236. | mask = cv.merge([mask] * 3) |
| 237. | avg_frame += comparison_frame * mask |
| 238. | inclusion_count += mask[:, :, 0] #pixel by |

pixel inclusion count

| | |
|---|---|
| 239. | |
| 240. | else: |
| 241. | for j in range(−iterations, iterations + 1): |
| 242. | if j == 0: |
| 243. | continue |
| 244. | idx = i + j |
| 245. | if 0 <= idx < num_present_frames : |
| 246. | comparison_frame = |

cv.imread(present_frame_files[idx])

| | |
|---|---|
| 247. | diff = cv.absdiff(current_frame, comparison_frame) |
| 248. | diff_gray = cv.cvtColor(diff, cv.COLOR_BGR2GRAY) |
| 249. | _, mask = cv.threshold(diff_gray, threshold1 * |

2.55, 1, cv.THRESH_BINARY_INV)

| | |
|---|---|
| 250. | mask = cv.merge([mask] * 3) |
| 251. | avg_frame += comparison_frame * mask |
| 252. | inclusion_count += mask[:, :, 0] |
| 253. | |
| 254. | avg_frame += current_frame |
| 255. | avg_frame /= inclusion_count[:, :, None] |
| 256. | output_path = os.path.join(output_folder, |

os.path.basename(present_filename))

| | |
|---|---|
| 257. | cv.imwrite(output_path, avg_frame.astype(np.uint8)) |

For each extracted frame, the post-processing device 1300 selects the appropriate synthetic frames that correspond to (e.g., are synthetic versions of) the extracted frame. This may include synthetic frames in multiple subfolders (corresponding to forward and backwards warping for each iteration).

Individual pixels of the selected synthetic frames may be selected for inclusion or exclusion in the denoised composite frame using a mask. Various types of masking may be used to exclude pixels that have a higher likelihood of distorting or degrading a composite frame. For example, portions of synthetic frames where there is a greater likelihood of ghosting or other artifacts may be excluded. Synthetic frames may include these artifacts based on imperfect motion detection (e.g., optical flow) estimations. For example, occlusions may be detected in synthetic frames/motion vector data applied to synthetic frames. Pixels of synthetic frames with detected or likely occlusions may be masked out of inclusion in the composite frame. In another example, luminance differences between the extracted frame and the corresponding synthetic frames may indicate areas of imperfect motion detection. Additionally, imperfections in motion detection (e.g. optical flow) may create composite frames that lack sharpness or have a blurry/out-of-focus appearance. Edge detection may be performed on extracted frames. An edge mask may be created for each extracted frame to apply to (e.g., exclude) pixels of synthetic frames on or within a number of pixels away from edges in the extracted frame. Multiple mask types may be combined, e.g., via a bitwise-and or bitwise-or operation.

In Pseudocode Segment 6 (lines 247-250), a luminance-difference mask may be calculated and applied to the synthetic frame. The difference between the current (extracted) frame and the comparison (synthetic) frame may be calculated (line 233 of Pseudocode Segment 6). The difference may be a per-element (e.g., per pixel, per sub-pixel) absolute difference between the frames. Components of the difference may be isolated. For example, the difference image data may be converted to grayscale (line 234 of Pseudocode Segment 6). A grayscale conversion may remove color data and isolate the luminance differences between the frames.

Isolating the luminance components/performing a grayscale conversion may differ based on the color space. As a brief aside, multiple color spaces may be used to represent a color. Two popular color spaces are RGB (Red, Green, Blue) and YCbCr (Luminance, Chrominance Blue, Chrominance Red). The RGB color space is an additive color model where colors are created by combining light of different wavelengths. The sub-pixel components directly map to how many systems generate colors with separate red, green, and blue values. Each sub-pixel component may have an equal range of values (e.g., a 0-255 value in 8-bit representation). The YCbCr color space separates the image into luminance (brightness) and chrominance (color) components. Luminance (Y) is a weighted sum of red, green, and blue components and represents the brightness of the color. Chrominance components (Cb and Cr) represent the difference between the blue and red components and the luminance, respectively. Mathematical transformations may be used to convert colors expressed in RBG to YCbCr and YCbCr to RBG. In RGB, a grayscale conversion may include computing a weighted sum of the red, green, and blue components (reflective of the human eye's sensitivity to different colors). In YCbCr, the Y component represents the luminance (brightness), and the Cb and Cr components may be ignored (or set to zero) to convert the pixel to grayscale. Those of ordinary skill will recognize that image manipulations are shown in the RGB color space, other color spaces may be used with equal success.

A mask may be created by the post-processing device 1300 by comparing the (isolated) difference data to a threshold (lines 249-250 of Pseudocode Segment 6). The threshold may indicate the maximum difference (e.g., the maximum luminance difference) allowed. In some examples, multiple thresholds may be used (e.g., four thresholds described in line 222 of Pseudocode Segment 6 and lines 62-80 of Pseudocode Segment 2). Different thresholds may be applied based on the iteration of the synthetic frame. The iteration may correspond to the temporal distance, e.g., the number of frames away, an extracted frame is from the current frame. In other words, the iteration may correspond to one more than the number of intermediate synthetic frames were used to generate the synthetic frame. Additionally, the iteration may correspond with the number of applications of motion vector data that was applied to the frame to transform the frame into a synthetic version of the current frame. Synthetic frames generated at higher iterations (in the forward and reverse directions) begin as temporally more distant frames. As a result, these synthetic frames may have more artifacts than synthetic frames generated at lower iterations. Accordingly, a lower difference threshold may be applied to higher iteration synthetic frames than lower iteration synthetic frames.

Entire synthetic frames may be excluded (e.g., masks set to all 0) where a number of difference values are above the difference threshold for compared to an exclusion threshold.

The mask may be applied to the synthetic frame (lines 251 of Pseudocode Segment 6) creating a masked synthetic frame. The mask may be applied on a per-pixel basis. The masked synthetic frames may be added to an accumulator (avg_frame). The masks may be added to an inclusion counter (inclusion_count). In other words, the inclusion counter may be incremented for pixels of the synthetic frame included in the accumulator. The current frame may be added to the accumulator. A current frame mask (e.g., all 1s) are added to the inclusion counter. To generate a denoised composite frame, the accumulator may be divided by the inclusion counter.

In some examples, the simple average of the pixels of the masked synthetic frames and the current frame may be calculated generate the denoised composite frame. In other examples, weights may be applied to the synthetic frames/current frame before being added to the accumulator. Corresponding weights may be applied to the masks before being added to the inclusion counter. For example, the current frame may have a higher weight than synthetic frames (e.g., twice as much weight). In other examples, the weight of the synthetic frames may be reduced as a function of the iteration. For example, the weight may be calculated as 1/(the iteration of the synthetic frame) or 1/(1+the iteration of the synthetic frame).

At step 1354, the control and data subsystem of the post-processing device 1300 may generate a denoised video based on the denoised composite frames. Pseduocode Segment 7 illustrates an exemplary function compile_to_video( ) for compiling/encoding the denoised composite frames into a denoised video. In some examples, FFMpeg libraries/utilities may be used to compile/encode the denoised composite frames into the denoised video. In some examples, motion vector (optical flow) data may be used during the encoding of the denoised video (e.g., during motion estimation and compensation/frame prediction).

Pseudocode Segment 7

| | |
|---|---|
| 258. | def compile_to_video(input_folder, output_file, crf=7): |
| 259. | # Adjusted FFmpeg command to match the “frame0001.jpg” naming |

convention

| | |
|---|---|
| 260. | command = f“ffmpeg -y -framerate 30 -i |

```
  {input_folder}/frame%04d.jpg -c:v libx264 -crf {crf} -pix_fmt yuv420p
  \“{output_file}\””
```

| | |
|---|---|
| 261. | print (“Executing command:”, command) # Debugging line to print |

the command

| | |
|---|---|
| 262. | result = subprocess.run(command, shell=True, capture_output=True, |

text=True)

| | |
|---|---|
| 263. | print(“FFmpeg Output:”, result.stdout) # Print FFmpeg's output |

for debugging

| | |
|---|---|
| 264. | print(“FFmpeg Errors:”, result.stderr) # Print FFmpeg's error |

messages, if any

At step 1356, the control and data subsystem of the post-processing device 1300 may perform cleanup operations. Pseduocode Segment 8 illustrates an exemplary function cleaup_folders( ) for removing temporary/intermediate files created during the denoising operation. In some examples, extracted frames, optical flow data, synthetic frames, and composite frames are deleted including the folders the temporary/intermediate files are stored in. In some examples, temporary/intermediate files are reused by other, e.g., post-processing, tasks and are not removed as part of the cleanup.

Pseudocode Segment 8

| | |
|---|---|
| 265. | def cleanup_folders( ): |
| 266. | folders_to_cleanup = [“input_large”, “input”, “flow-files”, |

“output”, “output2”, “output3”]

| | |
|---|---|
| 267. | for folder in folders_to_cleanup: |
| 268. | folder_path = os.path.join(os.getcwd( ), folder) |
| 269. | if os.path.exists(folder_path): |
| 270. | for root, dirs, files in os.walk(folder_path, |

topdown=False):

| | |
|---|---|
| 271. | for name in files: |
| 272. | os.remove(os.path.join(root, name)) |
| 273. | for name in dirs: |
| 274. | shutil.rmtree(os.path.join(root, name)) |

Additionally, the post-processing device 1300 may perform other post-processing activities on the denoised composite frames or denoised video (e.g., stabilization, etc.). Such processes may occur during (and using data generated via) denoising the video.

While the foregoing discussion is presented in the context of a specific order, other ordered combinations may be substituted with equal success. For example, as shown, all synthetic frames are created prior to masking/compositing. In other examples, synthetic frames may be generated rather than selected (or generated as needed just prior to masking and compositing with the current frame.

### Functional Overview of the Communication Network

As used herein, a communication network 1102 refers to an arrangement of logical nodes that enables data communication between endpoints (an endpoint is also a logical node). Each node of the communication network may be addressable by other nodes; typically, a unit of data (a data packet) may be traverse across multiple nodes in “hops” (a segment between two nodes). Functionally, the communication network enables active participants (e.g., capture devices and/or post-processing devices) to communicate with one another.

### Communication Networks, Implementation and Design Considerations

Aspects of the present disclosure may use an ad hoc communication network to, e.g., transfer data between the capture device 1200 and the post-processing device 1300. For example, USB or Bluetooth connections may be used to transfer data. Additionally, the capture device 1200 and the post-processing device 1300 may use more permanent communication network technologies (e.g., Bluetooth BR/EDR, Wi-Fi, 5G/6G cellular networks, etc.). For example, a capture device 1200 may use a Wi-Fi network (or other local area network) to transfer media (including video data) to a post-processing device 1300 (including e.g., a smart phone) or other device for processing and playback. In other examples, the capture device 1200 may use a cellular network to transfer media to a remote node over the Internet. These technologies are briefly discussed below.

So-called 5G cellular network standards are promulgated by the 3^{rd} Generation Partnership Project (3GPP) consortium. The 3GPP consortium periodically publishes specifications that define network functionality for the various network components. For example, the 5G system architecture is defined in 3GPP TS 23.501 (System Architecture for the 5G System (5GS), version 17.5.0, published Jun. 15, 2022; incorporated herein by reference in its entirety). As another example, the packet protocol for mobility management and session management is described in 3GPP TS 24.501 (Non-Access-Stratum (NAS) Protocol for 5G System (5G); Stage 3, version 17.5.0, published Jan. 5, 2022; incorporated herein by reference in its entirety).

Currently, there are three main application areas for the enhanced capabilities of 5G. They are Enhanced Mobile Broadband (eMBB), Ultra Reliable Low Latency Communications (URLLC), and Massive Machine Type Communications (mMTC).

Enhanced Mobile Broadband (eMBB) uses 5G as a progression from 4G LTE mobile broadband services, with faster connections, higher throughput, and more capacity. eMBB is primarily targeted toward traditional “best effort” delivery (e.g., smart phones); in other words, the network does not provide any guarantee that data is delivered or that delivery meets any quality of service. In a best-effort network, all users obtain best-effort service such that the overall network is resource utilization is maximized. In these network slices, network performance characteristics such as network delay and packet loss depend on the current network traffic load and the network hardware capacity. When network load increases, this can lead to packet loss, retransmission, packet delay variation, and further network delay, or even timeout and session disconnect.

Ultra-Reliable Low-Latency Communications (URLLC) network slices are optimized for “mission critical” applications that require uninterrupted and robust data exchange. URLLC uses short-packet data transmissions which are easier to correct and faster to deliver. URLLC was originally envisioned to provide reliability and latency requirements to support real-time data processing requirements, which cannot be handled with best effort delivery.

Massive Machine-Type Communications (mMTC) was designed for Internet of Things (IoT) and Industrial Internet of Things (IIOT) applications. mMTC provides high connection density and ultra-energy efficiency. mMTC allows a single GNB to service many different devices with relatively low data requirements.

Wi-Fi is a family of wireless network protocols based on the IEEE 802.11 family of standards. Like Bluetooth, Wi-Fi operates in the unlicensed ISM band, and thus Wi-Fi and Bluetooth are frequently bundled together. Wi-Fi also uses a time-division multiplexed access scheme. Medium access is managed with carrier sense multiple access with collision avoidance (CSMA/CA). Under CSMA/CA. During Wi-Fi operation, stations attempt to avoid collisions by beginning transmission only after the channel is sensed to be “idle”; unfortunately, signal propagation delays prevent perfect channel sensing. Collisions occur when a station receives multiple signals on a channel at the same time and are largely inevitable. This corrupts the transmitted data and can require stations to re-transmit. Even though collisions prevent efficient bandwidth usage, the simple protocol and low cost has greatly contributed to its popularity. As a practical matter, Wi-Fi access points have a usable range of ˜50 ft indoors and are mostly used for local area networking in best-effort, high throughput applications.

### Additional Configuration Considerations

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

As used herein any reference to any of “one embodiment” or “an embodiment”, “one variant” or “a variant”, and “one implementation” or “an implementation” means that a particular element, feature, structure, or characteristic described in connection with the embodiment, variant or implementation is included in at least one embodiment, variant, or implementation. The appearances of such phrases in various places in the specification are not necessarily all referring to the same embodiment, variant, or implementation.

As used herein, the term “computer program” or “software” is meant to include any sequence of human or machine cognizable steps which perform a function. Such program may be rendered in virtually any programming language or environment including, for example, Python, JavaScript, Java, C#/C++, C, Go/Golang, R, Swift, PHP, Dart, Kotlin, MATLAB, Perl, Ruby, Rust, Scala, and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die or distributed across multiple components.

As used herein, the terms “camera” or “image capture device” may be used to refer without limitation to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method of denoising a video, comprising:
estimating optical flow in the video;
generating synthetic frame corresponding to a frame of the video based on a neighboring frame of the frame and the optical flow;
masking the synthetic frame generating a masked synthetic frame;
generating a composite frame based on the masked synthetic frame and the frame; and
encoding the composite frame into a denoised video.

2. The method of claim 1, where masking the synthetic frame comprises:
calculating differences between pixel values of the synthetic frame and the frame; and
generating a mask based on the differences.

3. The method of claim 2, where generating the mask comprises comparing the differences to a difference threshold.

4. The method of claim 3, further comprising selecting the difference threshold based on a temporal distance between a first neighboring frame and the frame.

5. The method of claim 1, where masking the synthetic frame comprises:
calculating differences between a luminance component of pixels of the synthetic frame and the frame; and
generating a mask based on the differences.

6. The method of claim 1, where masking the synthetic frame comprises:
determining edges of the frame; and
generating a mask based on the edges.

7. The method of claim 1, where masking the synthetic frame comprises:
estimating areas of occluded motion based on the optical flow; and
generating a mask based on the areas of occluded motion.

8. The method of claim 1, where generating the synthetic frame comprises warping the neighboring frame based on the optical flow.

9. The method of claim 1, further comprising:
adding the masked synthetic frame to an accumulator; and
adding a mask used in masking the synthetic frame to an inclusion counter.

10. The method of claim 9, where generating the composite frame is based on dividing the accumulator by the inclusion counter.

11. A post-processing device, comprising:
a processor; and
a non-transitory computer-readable medium comprising a set of instructions that, when executed by the processor, causes the processor to:
extract frames of a video;
determine object motion in the video;
generate synthetic frames based on the object motion and the frames;
select portions of the synthetic frames for inclusion in composite frames; and
generate the composite frames based on the portions of the synthetic frames and the frames.

12. The post-processing device of claim 11, where the set of instructions further causes the processor to:
determine a number of iterations, where generating the synthetic frames is based on the number of iterations.

13. The post-processing device of claim 11, where the set of instructions further causes the processor to encode the composite frames into a denoised video.

14. The post-processing device of claim 11, where the set of instructions further causes the processor to:
select second portions of the synthetic frames for inclusion in double composite frames; and
generate the double composite frames based on the second portions of the synthetic frames and the composite frames.

15. The post-processing device of claim 14, where the set of instructions further causes the processor to encode the double composite frames into a denoised video.

16. A method of denoising a video, comprising:
extracting a plurality of frames from the video;
generating a plurality of optical flow files based on the video;
generating a plurality of synthetic frames corresponding to a frame of the video based on an optical flow estimation of the video;
performing a selective averaging of portions of the plurality of synthetic frames and the plurality of frames generating a plurality of composite frames; and
compiling a denoised video based on the plurality of composite frames.

17. The method of claim 16, further comprising generating scaled frames of the video, where generating the plurality of optical flow files is based on the scaled frames of the video.

18. The method of claim 16, where generating the plurality of synthetic frames comprises:
warping a first frame of the plurality of frames generating a first synthetic frame based on a first optical flow file of the plurality of optical flow files; and
warping the first synthetic frame generating a second synthetic frame based on a second optical flow file of the plurality of optical flow files.

19. The method of claim 18, where generating the plurality of composite frames comprises generating a first composite frame based on the first synthetic frame and a second frame of the plurality of frames, the second frame temporally adjacent to the first frame.

20. The method of claim 16, where performing the selective averaging of portions of the plurality of synthetic frames and the plurality of frames comprises:
selecting a first synthetic frame of the plurality of synthetic frames that mimic a first frame of the plurality of frames;
calculating a difference between a first luminance component of the first synthetic frame and a second luminance component of the first frame;
generating a mask by comparing the difference with a threshold;
applying the mask to the first synthetic frame generating a masked synthetic frame;
adding the first synthetic frame and the first frame to an accumulator;
adding the mask to an inclusion counter; and
generating a composite frame based on the accumulator and the inclusion counter.
